(19) United States
(12) Patent Application Publication
(10) Pub. No.: US 2026/0099625 A1
(43) Pub. Date: Apr. 9, 2026

(54) UTILIZING LARGE LANGUAGE MODELS TO GENERATE OBFUSCATED SUMMARIES OF EMPLOYEE FEEDBACK DATA AND MODIFICATION SUGGESTIONS BASED ON THE EMPLOYEE FEEDBACK DATA

(71) Applicant: Qualtrics, LLC, Provo, UT (US)

(72) Inventors: Recep Colak, Seattle, WA (US); Daniel Perry, Seattle, WA (US); Serena Jeblee, Toronto (CA)

(21) Appl. No.: 18/906,980

(22) Filed: Oct. 4, 2024

(51) Int. Cl. G06F 21/62; G06Q 10/0639

(52) U.S. Cl. CPC G06F 21/6245; G06Q 10/0639

(57) ABSTRACT

The present disclosure relates to systems, non-transitory computer-readable media, and methods for utilizing machine learning to generate an obfuscated summary for employee feedback data and generating a modification suggestion based on the employee feedback data. In particular, in one or more embodiments, the disclosed systems generate a prompt for an obfuscation and summary generation large language model to generate an obfuscated summary of employee feedback data and provide the obfuscated summary within a manager feedback interface on a manager client device. Moreover, in one or more embodiments, the disclosed systems receive a request to generate a modification suggestion from the manager feedback interface, then utilize a recommendation large language model to generate a modification suggestion based on the employee feedback data. Further, the disclosed systems provide the modification within the manager feedback interface on the manager client device.

### BACKGROUND

Recent years have seen significant improvements in conventional systems for providing feedback for various products, goods, and experiences. For example, conventional feedback systems can process unstructured text from digital feedback to identify information from the unstructured text. To illustrate, conventional feedback systems can summarize text to provide an overview of digital feedback that concisely captures the main points and essential information from unstructured text. In addition to generating summaries, conventional feedback systems often provide generalized modification suggestions when providing feedback summaries. For example, conventional systems provide modification suggestions that are generally applicable to many different systems and situations. Although conventional feedback systems can generate summaries and provide generalized feedback, conventional feedback systems suffer from a number of issues that exist in relation to flexibility of operation, accuracy, and efficiency.

For example, conventional feedback systems are inflexible. Specifically, conventional feedback systems often provide summaries that require a certain amount of feedback data to generate a summary. Conventional feedback systems that summarize sensitive feedback are particularly inflexible with the amount of feedback data they require to generate a summary. For instance, conventional feedback systems that summarize digital feedback data from employees providing feedback about direct superiors will only summarize feedback after receiving a large amount of feedback data. However, because conventional feedback systems are inflexible with the amount of feedback data, conventional feedback systems fail to provide feedback summaries for smaller systems, such as those with less employees.

In addition, conventional feedback systems are inaccurate. As mentioned, conventional feedback systems often provide generalized modification suggestions comprising modifications that would assist in many different situations. However, because general modification suggestions are not specific to the feedback, the feedback suggestions are often inaccurate in what they are displaying. Indeed, conventional systems often provide modification suggestions alongside feedback that is in direct contrast to displayed feedback summaries. For example, conventional feedback systems can provide a feedback summary that indicates that a manager is good at listening to employees while simultaneously providing a modification suggestion to listen to employees.

Furthermore, in the technology field of electronic feedback systems, a specific problem that arises is a data security issue that allows users to deduce or detect feedback data from a specific respondent. Providing feedback data to a user that can be linked back to a respondent is a data security risk that conventional electronic feedback systems face. To date, conventional electronic feedback systems have not effectively addressed the data security risk in a way that both allows communication of feedback data while at the same time maintaining data security. These, along with additional problems and issues, exist with regard to conventional electronic feedback systems.

### BRIEF SUMMARY

Embodiments of the present disclosure provide benefits and/or solve one or more of the foregoing or other problems in the art with systems, non-transitory computer-readable media, and methods for utilizing machine learning to generate an obfuscated summary for employee feedback data and generating a modification suggestion based on the employee feedback data. For example, in one or more embodiments, the disclosed systems generate a prompt for a large language model to generate an obfuscated summary of employee feedback data and provide the obfuscated summary within a manager feedback interface. Moreover, in one or more embodiments, the disclosed systems provide a summary of the employee feedback data within a manager feedback interface and, based on receiving a request to generate a modification suggestion, utilize a recommendation large language model to generate a modification suggestion based on the employee feedback data. Additional features and advantages of one or more embodiments of the present disclosure are outlined in the description that follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example diagram of an environment in which an obfuscated summary and modification suggestion system can operate in accordance with one or more embodiments.

FIG. 2 illustrates a schematic diagram of an overview of an obfuscated summary and modification suggestion system generating an obfuscated summary for employee feedback data and providing modification suggestions in a manager feedback interface in accordance with one or more embodiments.

FIG. 3 illustrates a schematic diagram of an obfuscated summary and modification suggestion system utilizing an obfuscation and summary generation large language model to generate obfuscated summaries and topic-level obfuscated summaries in accordance with one or more embodiments.

FIG. 4 illustrates a schematic diagram of an obfuscated summary and modification suggestion system generating a semantic summary metric and a summary quality metric to analyze the quality of obfuscated summaries from an obfuscation and summary generation large language model in accordance with one or more embodiments.

FIG. 5 illustrates a schematic diagram of an obfuscated summary and modification suggestion system utilizing a recommendation large language model to generate modification suggestions based on employee feedback data.

FIGS. 6A-6E illustrate example graphic user interfaces for providing obfuscated summaries and modification suggestions in a manager feedback interface in accordance with one or more embodiments.

FIGS. 7A-7F illustrate an example feedback widget for providing obfuscated summaries and modification suggestions from employee feedback data in accordance with one or more embodiments.

FIG. 8 illustrates a flowchart of a series of acts for generating an obfuscated summary of employee feedback data in accordance with one or more embodiments.

FIG. 9 illustrates a flowchart of a series of acts for providing a summary of employee feedback data and generating a modification suggestion based on the employee feedback data in accordance with one or more embodiments.

FIG. 10 illustrates a block diagram of an example computing device for implementing one or more embodiments of the present disclosure.

FIG. 11 illustrates a network of an experience management system in accordance with one or more embodiments.

### DETAILED DESCRIPTION

This disclosure describes one or more embodiments of an obfuscated summary and modification suggestion system that utilizes machine-learning models to generate an obfuscated summary of employee feedback data and generate a modification suggestion based on the employee feedback data. For example, the obfuscated summary and modification suggestion system utilizes a large language model to generate an obfuscated summary of employee feedback data and provide the obfuscated summary within a manager feedback interface. In addition, the obfuscated summary and modification suggestion system provides a summary of employee feedback data within a manager feedback interface and generates a modification suggestion based on the employee feedback data.

As mentioned, in one or more embodiments, the obfuscated summary and modification suggestion system generates an obfuscated summary of employee feedback data. In particular, the obfuscated summary and modification suggestion system generates a prompt with the employee feedback data and provides the prompt to an obfuscation and summary generation language model to generate the obfuscated summary of the employee feedback data. Moreover, the obfuscated summary and modification suggestion system can generate a high-level obfuscated summary that provides an overall summary of the employee feedback data and topic-level obfuscated summaries indicating topics identified within the employee feedback data. In some cases, the obfuscated summary and modification suggestion system also generates a semantic similarity metric and a summary quality metric to analyze the obfuscated summary from the obfuscation and summary generation large language model.

As also mentioned, in one or more embodiments, the obfuscated summary and modification suggestion system generates a modification suggestion based on employee feedback data. Specifically, the obfuscated summary and modification suggestion system provides a summary (or an obfuscated summary) of feedback data within a manager feedback interface on a manager client device and, based on receiving a request to generate a modification suggestion, generates a modification suggestion based on the employee feedback.

Further, as mentioned, the obfuscated summary and modification suggestion system provides an obfuscated summary and/or a modification suggestion in a manager feedback interface on a manager client device. Specifically, the obfuscated summary and modification suggestion system provides a manager feedback interface with which a manager client device can interact to, among other things, generate and/or view obfuscated summaries, request modification suggestions, and identify topics within employee feedback data. In some cases, the obfuscated summary and modification suggestion system utilizes a feedback widget associated with the manager feedback interface that can utilize the employee feedback data to generate obfuscated summaries, modification summaries, and/or allow for interactions to view topics in the employee feedback data.

Moreover, as mentioned, the obfuscated summary and modification suggestion system provides obfuscated summaries and modification suggestions based on employee feedback data. In one or more embodiments, the obfuscated summary and modification suggestion system provides a digital feedback survey to employee client devices and receives employee feedback data in responses to the digital survey. In addition, the obfuscated summary and modification suggestion system can generate an obfuscated summary based on a number of employees or instances of employee feedback data received. For example, the obfuscated summary and modification suggestion system can determine that a number of employee devices providing employee feedback data satisfy an obfuscated summary threshold and generate an obfuscated summary of the employee feedback data. However, if the number of employee devices providing employee feedback data does not satisfy an obfuscated summary threshold, the obfuscated summary and modification suggestion system can generate a summary (e.g., non-obfuscated) of the employee feedback data.

The obfuscated summary and modification suggestion system provides a variety of technical advantages relative to conventional systems. For example, by generating obfuscated summaries, the obfuscated summary and modification suggestion system improves flexibility relative to conventional systems. Specifically, the obfuscated summary and modification suggestion system generates obfuscated summaries that paraphrase and rewrite a summary in a way that the original author is not identifiable while still summarizing and communicating ideas, thoughts, and sentiments from the feedback data. Moreover, the obfuscated summary and modification suggestion system identifies a number of instances of feedback and intelligently determines when to generate an obfuscated summary of the feedback data or a summary (e.g., non-obfuscated) of the feedback data. Indeed, because the obfuscated summary and modification suggestion system intelligently determines when to generate an obfuscated summary or a summary, the obfuscated summary and modification suggestion system can summarize feedback data for systems with a wide range of employees to provide feedback, unlike conventional systems that cannot provide feedback to smaller systems.

In addition, the obfuscated summary and modification suggestion system improves accuracy relative to conventional feedback systems. Specifically, unlike conventional systems that simply select general feedback to provide a summary, the obfuscated summary and modification suggestion system generates modification suggestions from the employee feedback data. By generating modification suggestions from employee feedback data, the obfuscated summary and modification suggestion system generates specific and personalized feedback that corresponds to the summaries (obfuscated and non-obfuscated) provided in a manager feedback interface or a feedback widget. Thus, unlike conventional systems that often provide modification suggestions that fail to capture suggestions from feedback, the obfuscated summary and modification suggestion system accurately generates modification suggestions that capture the ideas in the employee feedback data.

Moreover, and as discussed above, within the technology field of electronic feedback systems, a specific problem that arises is a data security issue that allows users to deduce or link feedback data to a specific respondent. The obfuscated summary and modification suggestion system described herein, however, provides a technical solution that solves the data security issue that arose in the field of electronic feedback systems. In particular, the obfuscated summary and modification suggestion system uses specially designed computer systems and trained machine learning models to determine when it is necessary to provide additional data security for a feedback data summary. Moreover, the obfuscated summary and modification suggestion system uses the trained machine learning models along with verification systems to obfuscate a feedback data summary to ensure that the obfuscated feedback data summary is secure and does not allow a reader to link the feedback data to a particular respondent. Thus, using the technical solutions and processes described here, the obfuscated summary and modification suggestion system solve the data security issue that arose within the field of electronic feedback systems.

As illustrated by the foregoing discussion, the present disclosure utilizes a variety of terms to describe features and advantages of the obfuscated summary and modification suggestion system. Additional details regarding the meaning of such terms are now provided. For example, as used herein, the term “employee feedback data” refers to information collected from employees who share experiences, opinions, or responses. In particular, the term “employee feedback data” refers to unstructured text, digital responses, or other data that comprises qualitative and quantitative received from employees (e.g., through employee client devices). To illustrate, employee feedback data can include responses to a digital survey provided to employee client devices that requests feedback about a company, management, job satisfaction, company policies, tools, resources, and compensation.

Additionally, as used herein, the term “obfuscated summary” refers to a summary that summarizes employee feedback data while paraphrasing or rewriting the employee feedback data to remove potentially identifying information. In particular, the term “obfuscated summary” refers to a summarization of employee feedback data that amends the employee feedback data to obscure the source of the employee feedback data while maintaining the information, ideas, and sentiments. An obfuscated summary can come from a single instance of employee feedback data or can be a summary of multiple instances of employee feedback data. To illustrate, for a source text comprising the phrase “trust managers to select the best talent for a job and do not push them to meet any quotas,” an obfuscated summary could be “empower management to employ the greatest competence available without being influenced by numerical obligations.” In addition, the term “high-level obfuscated summary” refers to an obfuscated summary that summarizes a larger instance of employee feedback data or multiple instances of employee feedback data. For example, a high-level obfuscated summary can identify recurring (or overall) ideas, sentiments, and ideas found in employee feedback data. Moreover, the term “topic-level obfuscated summary” refers to an obfuscated summary of a topic found within employee feedback data. For example, a topic-level obfuscated summary refers to an obfuscated summary that summarizes a topic identified in employee feedback data.

In addition, as used herein, the term “machine-learning model” refers to a computer algorithm or a collection of computer algorithms that automatically improve for a particular task through iterative outputs or predictions based on the use of data. For example, a machine-learning model can utilize one or more learning techniques to improve accuracy and/or effectiveness. Example machine-learning models include various types of neural networks, decision trees, support vector machines, linear regression models, and Bayesian networks.

Relatedly, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items or smart topic outputs) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a machine-learning model.

In addition, as used herein, the term “large language model” refers to a machine-learning model trained to perform computer tasks to generate or identify content items in response to trigger events (e.g., user interactions, such as text queries and button selections). In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., smart topic outputs) based on prompts and/or to identify content items based on various contextual data, including graph information from a knowledge graph and/or historical user account behavior. In some cases, a large language model comprises various commercially available models such as, but not limited to, GPT (e.g., GPT 3.5, GPT 4), ChatGPT, Llama (e.g., Llama2-7B, Llama 3), BERT, Claude, Cohere.

As used herein, the term “obfuscation and summary generation large language model” refers to one or more large language models trained or tuned to generate obfuscated summaries. For example, an obfuscation and summary generation large language model can utilize a prompt that comprises employee feedback data and an instruction to generate an obfuscated summary of employee feedback data. In some cases, an obfuscation and summary generation large language model is a GPT model (e.g., GPT3.5Turbo, GPT 4), Claude (e.g., Claude V2 100k, Claude V1, Llama (e.g., Llama2-13b-chat), Mistral (e.g., Mistral-7b-chat).

Moreover, as used herein, the term “recommendation large language model” refers to one or more machine-learning models trained or tuned to generate modification suggestions based on employee feedback data. For example, a recommendation large language model can utilize a prompt to generate a modification suggestion based on multiple instances of employee feedback data or a single instance of employee feedback data.

Also, as used herein, the term “semantic similarity metric” refers to a quantitative measure used to determine how similar two pieces of text are in meaning. In particular, “semantic similarity metric” refers to a metric that assesses the conceptual and contextual likeness between two texts and can be used to compare words, phrases, sentences, or entire documents. To illustrate, a semantic similarity metric can be from a scale of zero (completely dissimilar) to one (identical). Moreover, a semantic similarity score can be generated utilizing various techniques, including word embeddings, deep learning models, or lexical databases.

Moreover, as used herein, the term “summary quality metric” refers to a quantitative metric for evaluating machine-generated text. In particular, “summary quality metric” refers to a metric used to assess the quality of machine-generated summaries or translations by comparing them to reference (e.g., human-generated) summaries. To illustrate, a summary quality metric can be a recall-oriented understudy for gisting evaluation (“ROUGE”) score.

Also, as used herein, the term “topic” refers to a subject identified in employee feedback data. In particular, the term “topic” refers to a matter with which unstructured text or digital response answers (e.g., selections of responses to answers) within employee feedback data. To illustrate, a topic can include an area of the system, product, event, person, or process with which the employee dealt. For example, if an employee provided feedback about a manager in employee feedback data, the topic of a segment could refer to meetings, attitudes, or skills.

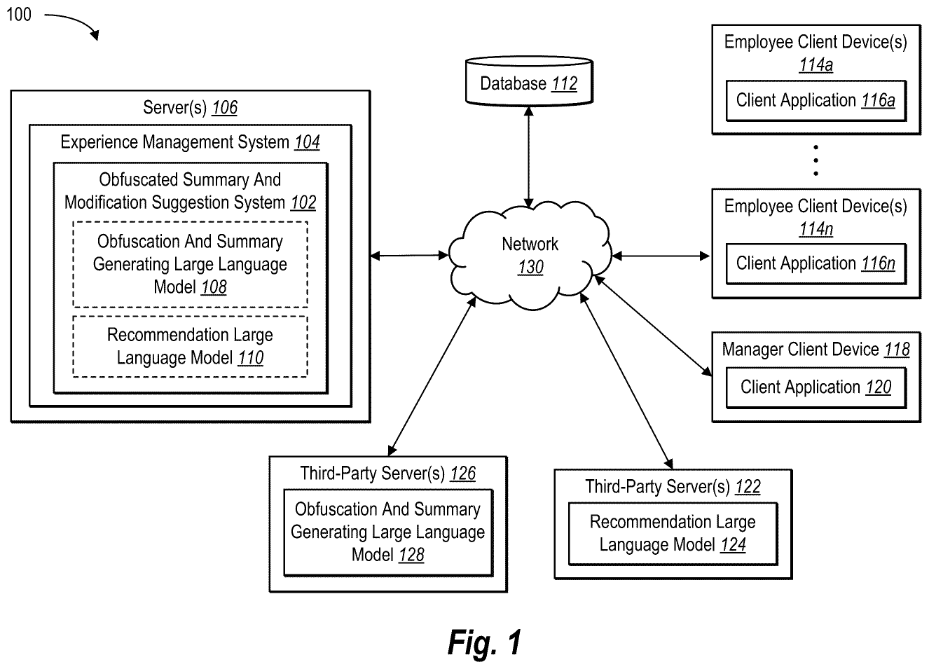

Additional details regarding the obfuscated summary and modification suggestion system will now be provided with reference to the figures. For example, FIG. 1 illustrates an example diagram of an environment in which an obfuscated summary and modification suggestion system can operate in accordance with one or more embodiments. An overview of the obfuscated summary and modification suggestion system is described in relation to FIG. 1. Thereafter, a more detailed description of the components and processes of the obfuscated summary and modification suggestion system is provided in relation to the subsequent figures.

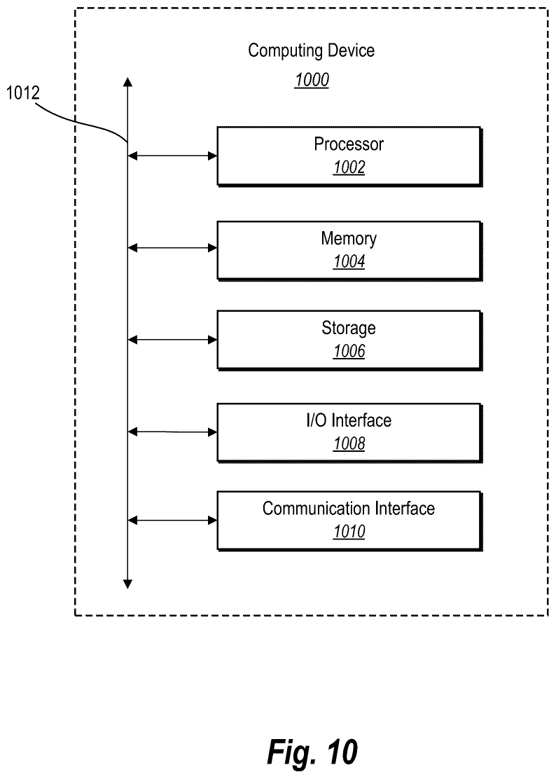

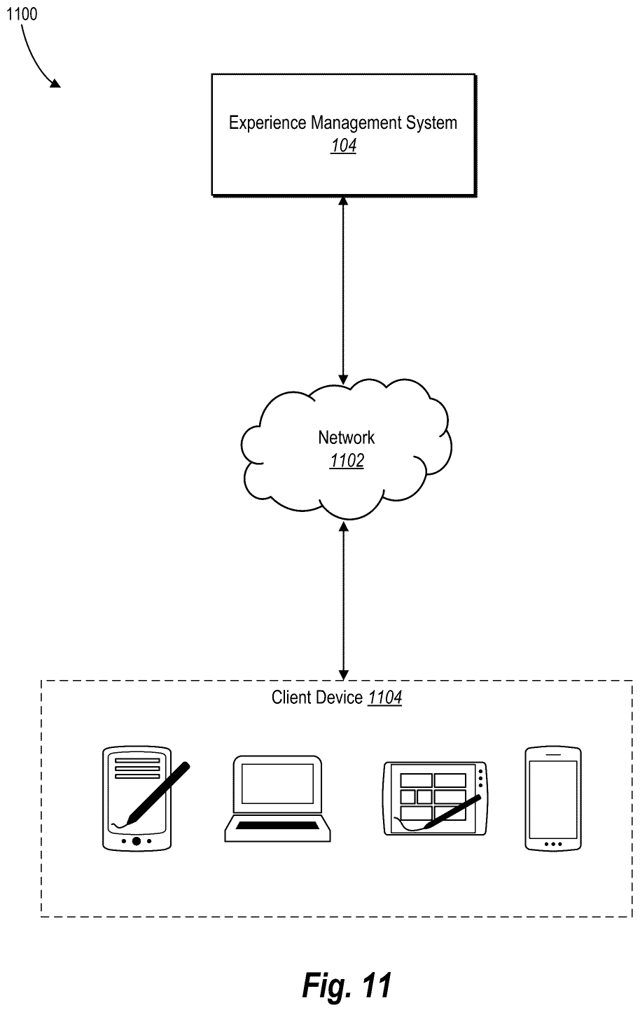

As shown, the environment 100 includes the server(s) 106, database 112, employee client device(s) 114a-114n, manager client device 118, third-party server(s) 122, and third-party server(s) 126. Each of the components of environment 100 can communicate via network 130, and network 130 can be any suitable network over which a computing device can communicate. Example networks are discussed in more detail below in relation to FIGS. 10-11.

As mentioned above, environment 100 includes employee client device(s) 114a-114n and manager client device 118. The manager client device 118 may be associated with an administrator of the experience management system 104 and/or the obfuscated summary and modification suggestion system 102. The employee client device(s) 114a-114n or the manager client device 118 can be one of a variety of computing devices, including a smartphone, a tablet, a smart television, a desktop computer, a laptop computer, a virtual reality device, an augmented reality device, or another computing device as described in relation to FIGS. 10-11. The employee client device(s) 114a-114n and the manager client device 118 can communicate with the server(s) 106 via network 130. For example, the employee client device(s) 114a-114n or the manager client device 118 can receive user input from a user interacting with the employee client device(s) 114a-114n (e.g., via the client application 116a-116n) or the manager client device 118 to, for instance, select interface elements to interact with an experience management system or to select options that provide employee feedback data. In addition, the obfuscated summary and modification suggestion system 102 or the server(s) 106 can receive information relating to various interactions and/or user interface elements based on the input received by the employee client device(s) 114a-114n or the manager client device 118.

As shown, the employee client device(s) 114a-114n can include a client application 116a-116n. In particular, the client application 116a-116n may be a web application, a native application installed on the employee client device(s) 114a-114n (e.g., a mobile application, a desktop application, etc.), or a cloud-based application where all or part of the functionality is performed by the server(s) 106. Based on instructions from the client application 116a-116n, the employee client device(s) 114a-114n can present or display information, including a user interface for interacting with (or collaborating regarding) initiating tasks. Using the client application, the employee client device(s) 114a-114n can perform (or request to perform) various operations, such as executing a task and/or inputting text comprising actions or prompts to generate a specific output. Though not shown, the manager client device 118 can include a client application that allows for or provides specific functionality for an administrator of the experience management system 104 or the obfuscated summary and modification suggestion system 102.

As illustrated in FIG. 1, the environment 100 also includes the server(s) 106. The server(s) 106 may generate, track, store, process, receive, and transmit electronic data, such as results, actions, determinations, responses, computer code, interactions with interface elements, and/or interactions between user accounts or client devices. For example, the server(s) 106 may receive an indication from the employee client device(s) 114a-114n or the manager client device 118 of a user interaction selecting an option that initiates a task or inputting text comprising actions or prompts to generate a specific output. In addition, the server(s) 106 can transmit data to the employee client device(s) 114a-114n or the manager client device 118. Indeed, the server(s) 106 can communicate with the employee client device(s) 114a-114n or the manager client device 118 to send and/or receive data via network 130. In some implementations, server(s) 106 comprises a distributed server where the server(s) 106 include(s) a number of server devices distributed across the network 130 and located in different physical locations. The server(s) 106 can comprise one or more content servers, application servers, container orchestration servers, communication servers, web-hosting servers, machine-learning servers, and other types of servers.

As shown in FIG. 1, the server(s) 106 can also include the obfuscated summary and modification suggestion system 102 as part of the experience management system 104. The experience management system 104 can communicate with the employee client device(s) 114a-114n to perform various functions associated with the client application(s) 116a-116n, such as managing accounts, initiating tasks, and/or receiving user preferences. Indeed, experience management system 104 can manage, store, and maintain user profiles and preferences associated with the employee client device(s) 114a-114n. In some embodiments, the obfuscated summary and modification suggestion system 102 and/or the experience management system 104 utilize the database 112 to store and access information pertaining to user profiles, user preferences, topics, or other data related to determining contexts for interactions.

As also illustrated in FIG. 1, the obfuscated summary and modification suggestion system 102 (or the experience management system 104) can optionally host an obfuscation and summary generating large language model 108 and a recommendation large language model 110. In particular, the experience management system 104 can optionally host an obfuscation and summary generating large language model 108 local to the obfuscated summary and modification suggestion system 102 that is trained to generate obfuscated summaries for employee feedback data. Moreover, the obfuscated summary and modification suggestion system 102 can host a recommendation large language model 110 that is trained to generate modification suggestions from employee feedback data. For example, when the obfuscated summary and modification suggestion system 102 hosts obfuscated summary and modification suggestion large language model 108 and/or recommendation large language model 110, they operate within a firewall of the obfuscated summary and modification suggestion system 102 (or the experience management system 104), utilizing secure data and information that is part of the obfuscated summary and modification suggestion system 102.

Further, as illustrated in FIG. 1, the obfuscated summary and modification suggestion system 102 can also utilize large language models hosted on various third-party servers. For example, in one or more embodiments, the obfuscated summary and modification suggestion system 102 utilizes an obfuscation and summary generating large language model 128 hosted on third-party server(s) 126 and a recommendation large language model 124 hosted on third-party server(s) 122. When an obfuscation and summary generating large language model and recommendation large language model is hosted on a third-party server, and therefore outside the firewall of the obfuscated summary and modification suggestion system 102, the obfuscated summary and modification suggestion system 102 can remove sensitive information and/or data from employee feedback data. In some cases, the obfuscation and summary generation large language model 128 or the recommendation large language model 124 refers to various third-party hosted large-learning models (e.g., ChatGPT, Lambda, Llama, BERT, RoBERTa, Turing-NLG, T5, XLNet).

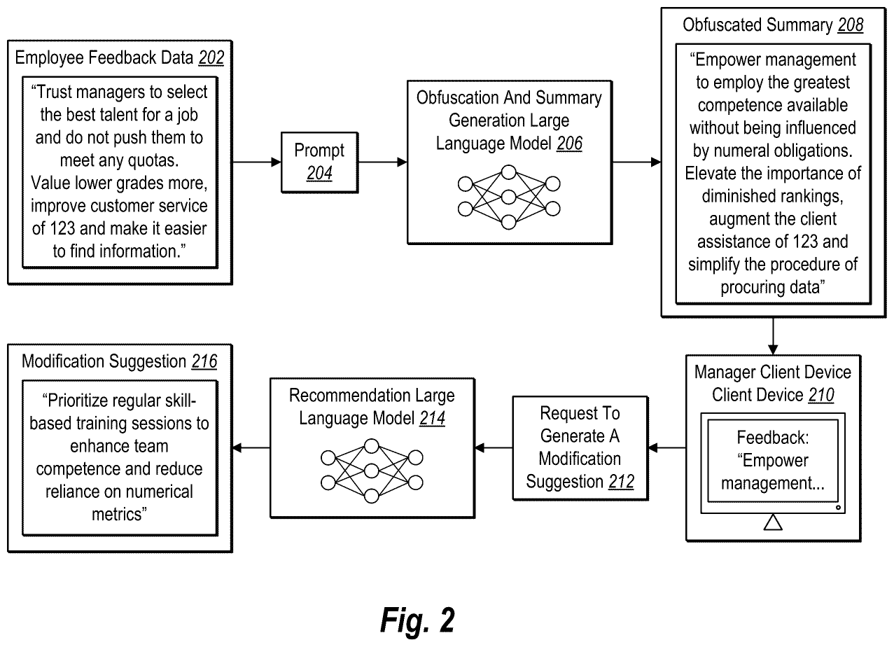

As mentioned, the obfuscated summary and modification suggestion system 102 can generate an obfuscated summary of employee feedback data and provide a modification suggestion based on the employee feedback data. In particular, the obfuscated summary and modification suggestion system 102 provides the obfuscated summary on a manager client device and, based on receiving a request to generate a modification suggestion from the manager client device, generates a modification suggestion from the employee feedback data. FIG. 2 illustrates a schematic diagram of an overview of an obfuscated summary and modification suggestion system generating an obfuscated summary for employee feedback data and providing modification suggestions in a manager feedback interface in accordance with one or more embodiments.

As shown, the obfuscated summary and modification suggestion system 102 receives employee feedback data 202. Specifically, the obfuscated summary and modification suggestion system 102 receives employee feedback data from employee client devices, and where the employee feedback data comprises responses to digital surveys. For example, the obfuscated summary and modification suggestion system 102 provides digital surveys to employee client devices, where the digital surveys request employee feedback data regarding employment conditions.

As also shown, the obfuscated summary and modification suggestion system 102 generates a prompt 204. In particular, the obfuscated summary and modification suggestion system 102 generates a prompt 204 for an obfuscation and summary generation large language model 206 to generate an obfuscated summary 208 from employee feedback data 202. For example, the obfuscated summary and modification suggestion system 102 generates a prompt that comprises a portion of employee feedback data and specialized instructions for generating an obfuscated summary of employee feedback data.

As mentioned, the obfuscated summary and modification suggestion system 102 utilizes an obfuscation and summary generation large language model 206. Specifically, the obfuscated summary and modification suggestion system 102 utilizes an obfuscation and summary generation large language model 206 that is trained to generate obfuscated summaries for employee feedback data. For example, the obfuscated summary and modification suggestion system 102 is trained to utilize prompts that summarize and obfuscate employee feedback data.

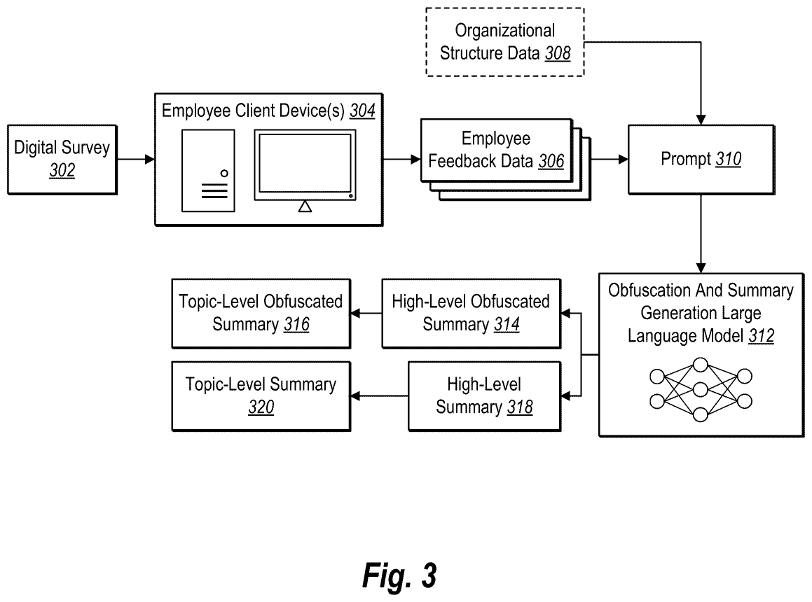

In addition, as mentioned, the obfuscated summary and modification suggestion system 102 generates obfuscated summary 208 of employee feedback data 202. Specifically, the obfuscated summary and modification suggestion system 102 utilizes the obfuscation and summary generation large language model 206 to generate a summary of the employee feedback data that modifies the employee feedback data to conceal the identities of the source while ensuring that information, ideas, and sentiments, are preserved intact. For example, the obfuscated summary and modification suggestion system 102 paraphrases or rewrites employee feedback data so that it includes insights, concepts, and perspectives but does not comprise the distinctive voice, personal style, or unique tone of the employee feedback data. Additional data regarding the obfuscated summary and modification suggestion system 102 receiving employee feedback data, generating prompts, and utilizing an obfuscation and summary generation large language model to generate obfuscated summaries is provided below with respect to FIG. 3.

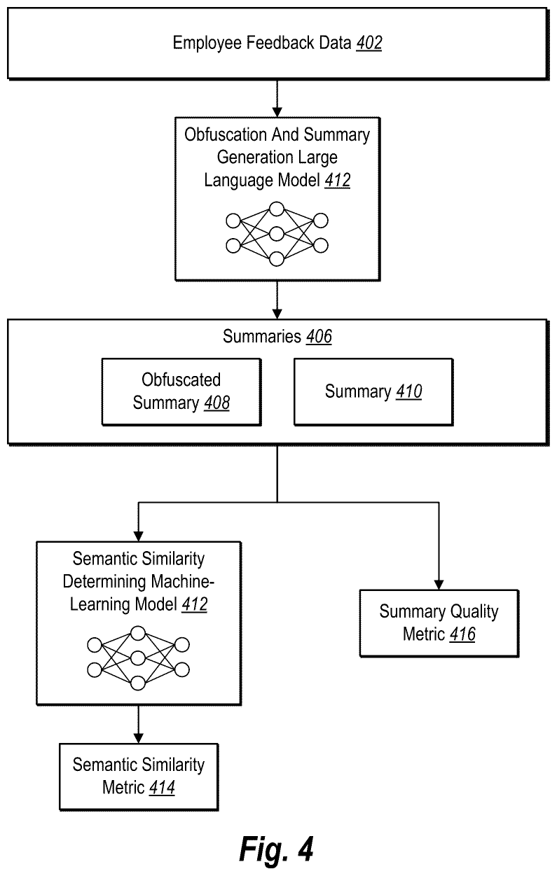

In addition, in one or more embodiments, the obfuscated summary and modification suggestion system 102 analyzes obfuscated summaries from the obfuscation and summary generation large language model. Specifically, the obfuscated summary and modification suggestion system 102 provides an obfuscated summary to a summary quality machine-learning model to generate obfuscated summary metrics. For example, the summary quality machine-learning model generates a semantic summary metric and a summary quality metric that indicates the quality of the obfuscated summary from the obfuscation and summary generation large language model. Additional details regarding the obfuscated summary and modification suggestion system 102 utilizing a summary quality machine-learning model to generate obfuscated summary metrics to analyze the obfuscated summaries from an obfuscation and summary generation large language model are provided below with respect to FIG. 4.

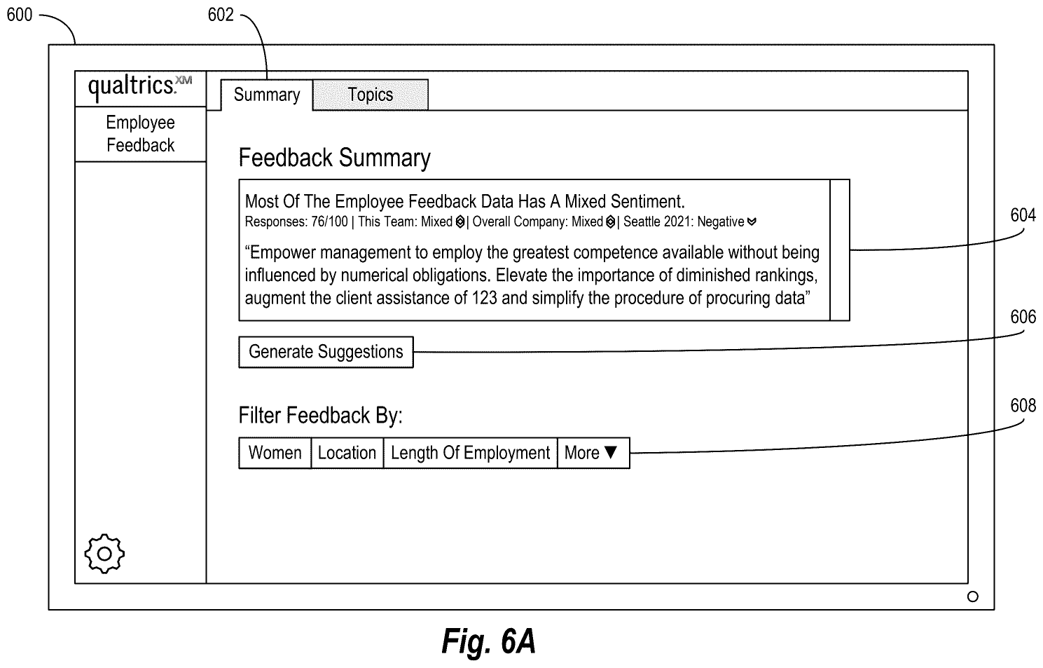

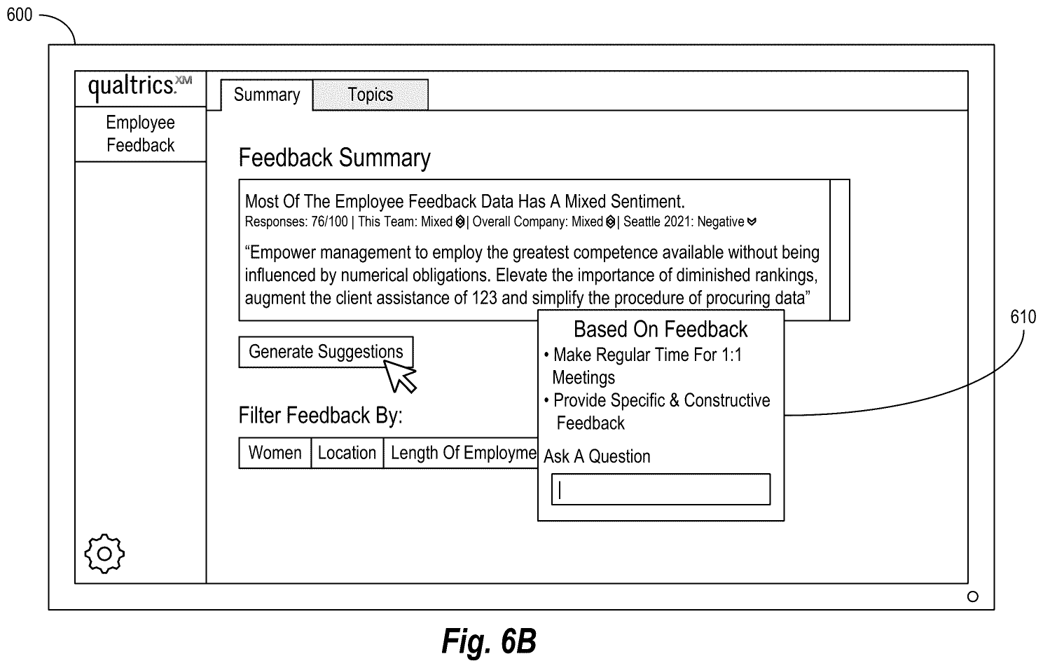

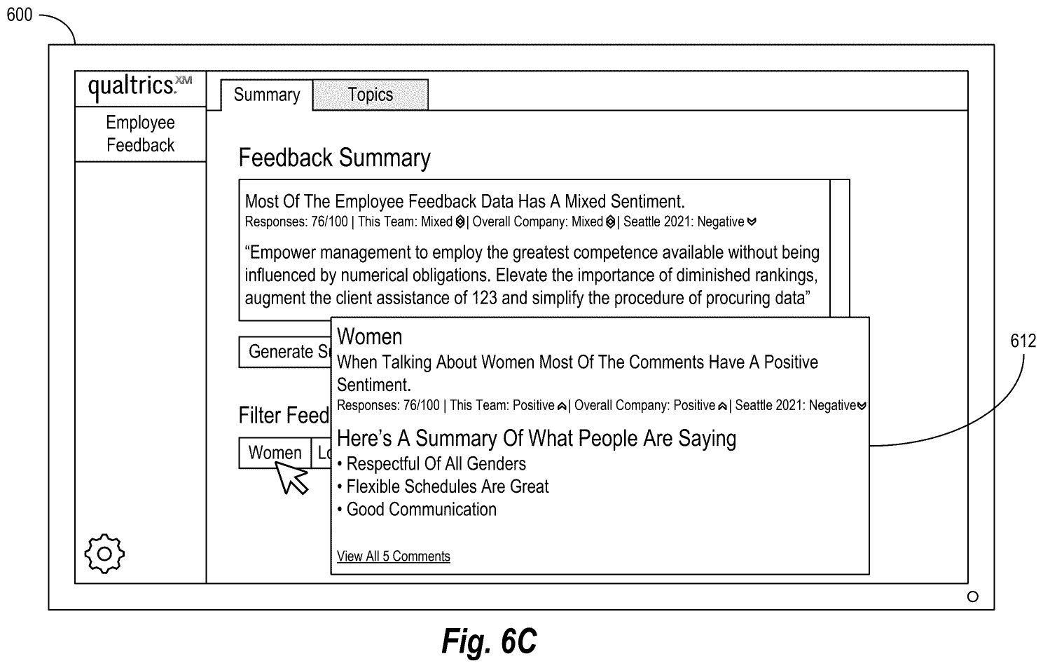

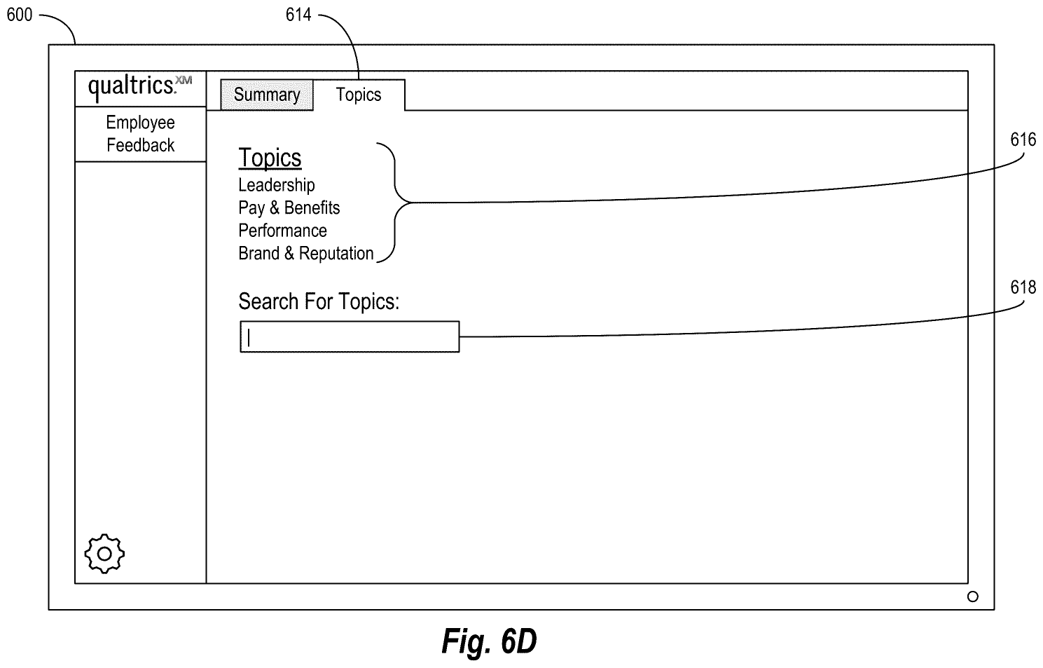

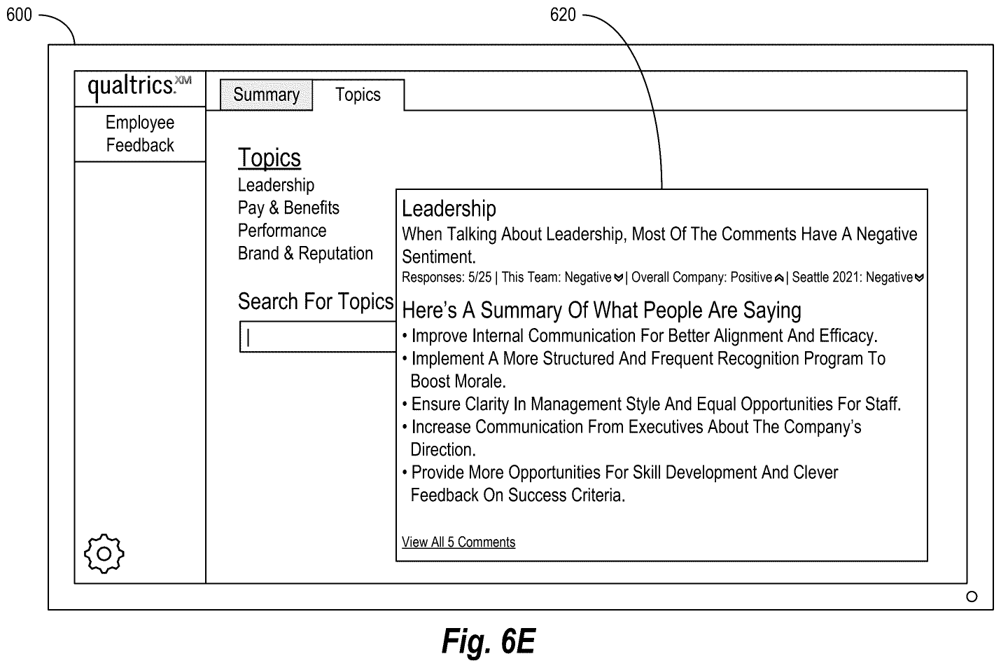

As also shown in FIG. 2, the obfuscated summary and modification suggestion system 102 provides obfuscated summary 208 on a manager client device 210. In particular, the obfuscated summary and modification suggestion system 102 provides obfuscated summary 208 within a manager feedback interface on a manager client device. Moreover, from within the manager feedback interface, the obfuscated summary and modification suggestion system 102 can receive user interactions to interact with the obfuscated summaries and/or the employee feedback data. Additional details and examples of manager feedback interfaces are provided with respect to FIGS. 6A-6E below.

In addition, as shown, the obfuscated summary and modification suggestion system 102 receives a request to generate a modification suggestion 212. Specifically, the obfuscated summary and modification suggestion system 102 receives a request from a manager client device to generate a modification suggestion. For example, the obfuscated summary and modification suggestion system 102 can receive a user interaction with an option to generate a modification suggestion, receive a selection of an option to generate a modification suggestion based on modification suggestion templates or receive a text input of a question about the employee feedback data.

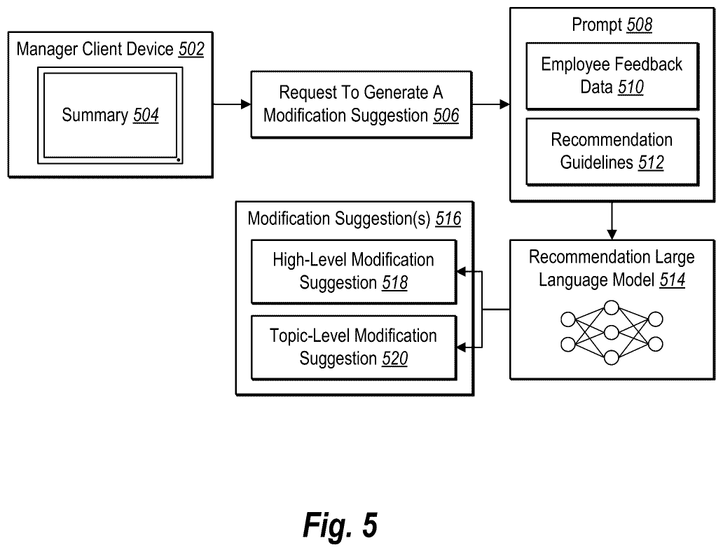

As shown, based on receiving the request to generate modification suggestion 212, the obfuscated summary and modification suggestion system 102 utilizes a recommendation large language model 214 to generate a modification suggestion 216. In particular, the recommendation large language model 214 generates personalized modification suggestions that comprise specific recommendations based on the employee feedback data. For example, the obfuscated summary and modification suggestion system 102 provides a prompt comprising portions of employee feedback data and instructions to generate modification suggestions utilizing template guidelines. Additional details regarding the obfuscated summary and modification suggestion system 102 utilizing a recommendation large language model to generate modification suggestions are provided below with respect to FIG. 5.

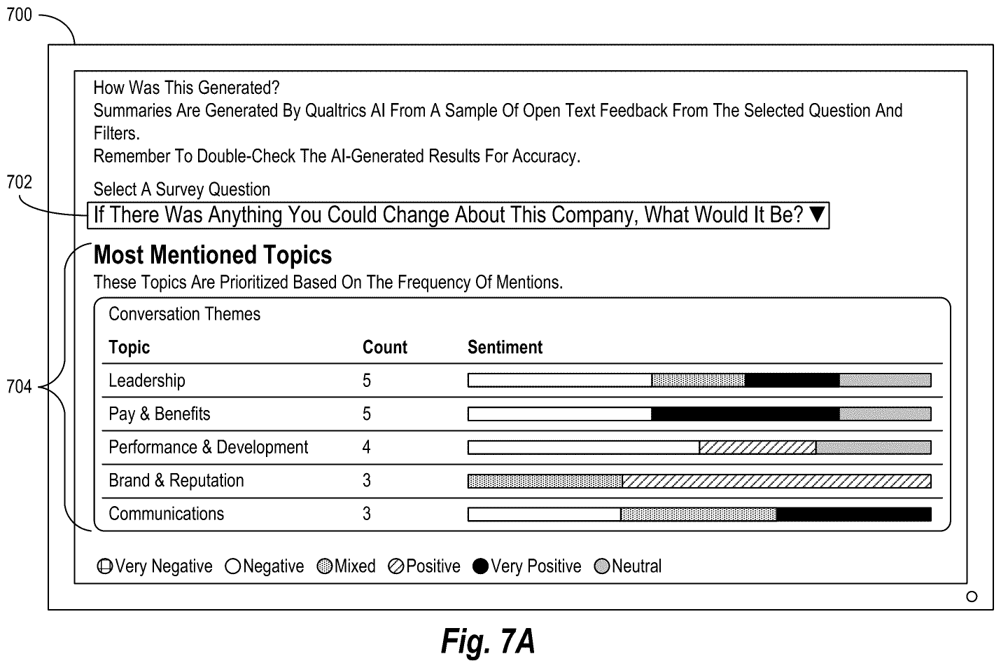

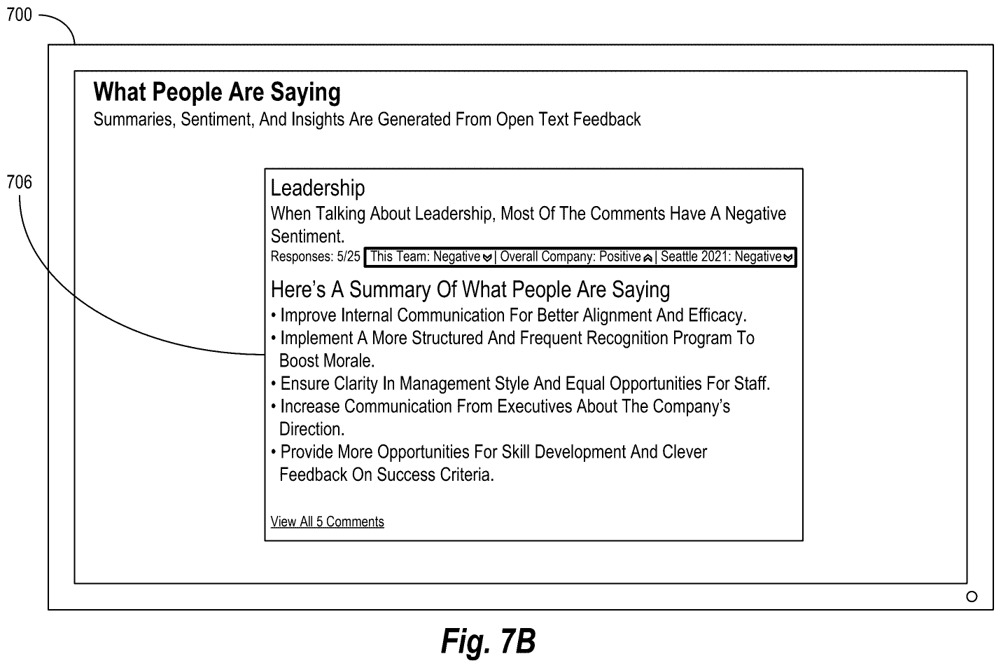

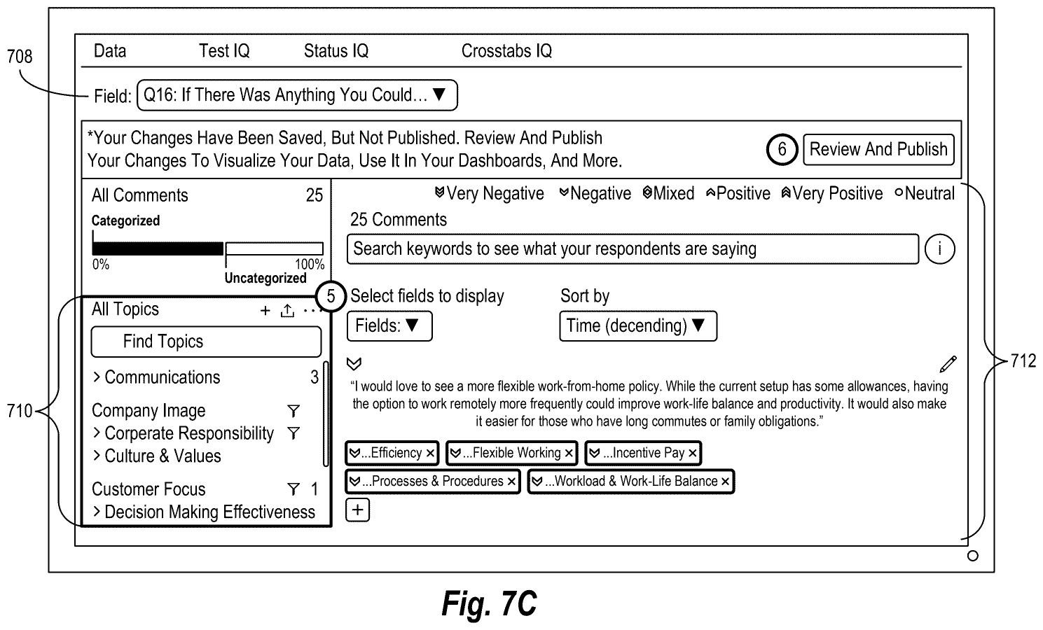

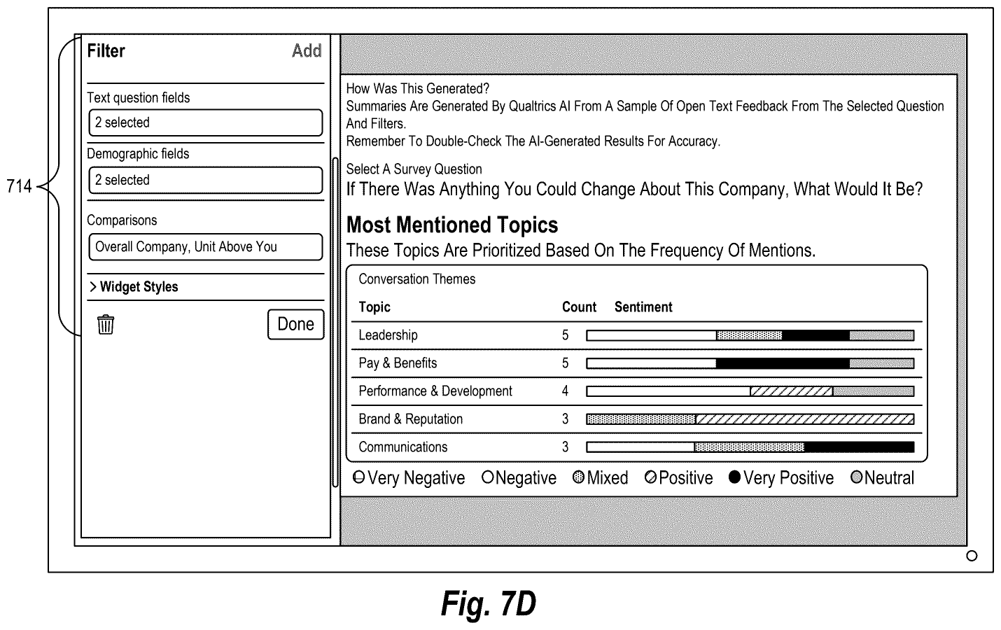

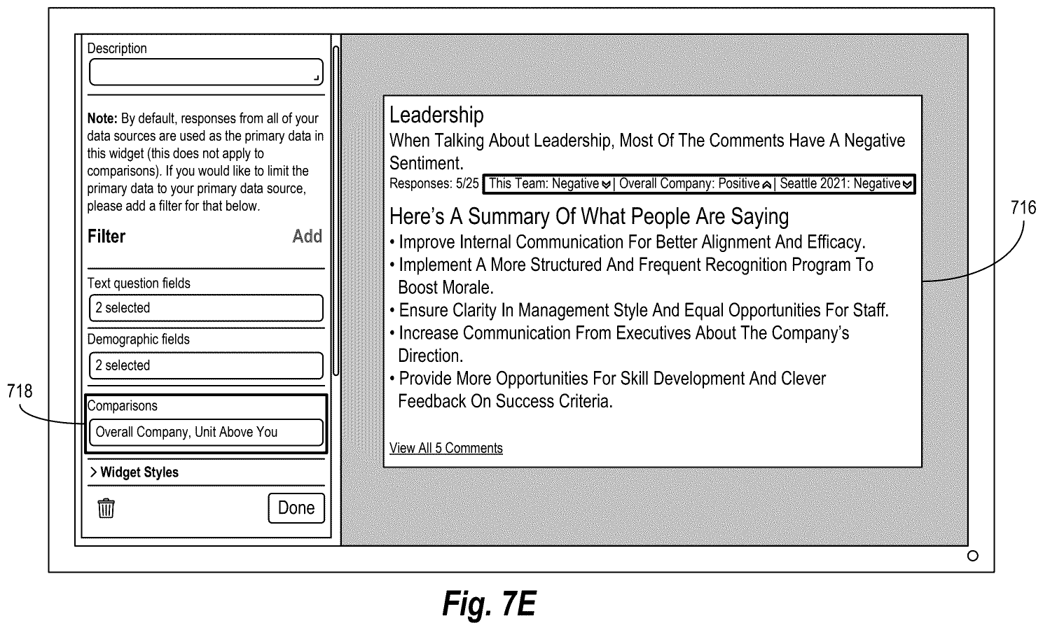

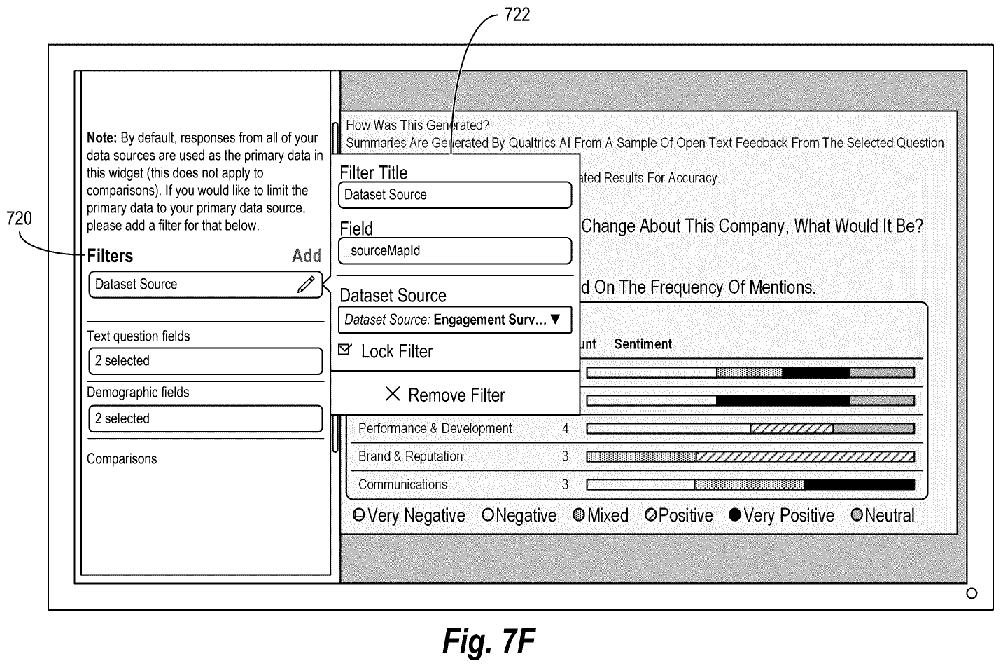

In one or more embodiments, the obfuscated summary and modification suggestion system 102 provides obfuscated summaries and modification suggestions in a feedback widget. In particular, the obfuscated summary and modification suggestion system 102 provides a feedback widget associated with the manager feedback interface that provides modification suggestions and summaries and receives employee feedback for viewing summaries and generating modification suggestions. For example, the obfuscated summary and modification suggestion system 102 provides customized displays of summaries and modification suggestions. Additional details and examples of a feedback widget are provided with respect to FIGS. 7A-7E below.

As mentioned, the obfuscated summary and modification suggestion system 102 generates obfuscated summaries of employee feedback data. Specifically, the obfuscated summary and modification suggestion system 102 utilizes an obfuscation and summary generation large language model to generate obfuscated summaries and topic-level obfuscated summaries from employee feedback data. FIG. 3 illustrates a schematic diagram of an obfuscated summary and modification suggestion system utilizing an obfuscation and summary generation large language model to generate obfuscated summaries and topic-level obfuscated summaries in accordance with one or more embodiments.

As shown, the obfuscated summary and modification suggestion system 102 provides digital survey 302 to employee client device(s) 304. Specifically, the obfuscated summary and modification suggestion system 102 provides a digital survey 302 that collects information concerning one or more respondents by capturing information from (or posing questions to) such respondents. For example, the digital survey can solicit information or feedback from employees regarding leadership and/or management performance, compensation, work environment and culture, professional development, communication, teamwork, and productivity.

In one or more embodiments, employee client device(s) 304 can respond to digital survey 302 with employee feedback data 306. Specifically, employee client device(s) 304 can provide employee feedback data in responses to questions of digital survey 302 by providing a selection, a text input, audio input, or other user input indicating a response to a question of the digital survey. Further, a response can include metadata associated with the response, including data on a corresponding digital survey question, data regarding a survey respondent (e.g., the employee of the employee client device), and other data about the digital survey response.

As mentioned, in some cases, the obfuscated summary and modification suggestion system 102 receives employee feedback data 306 by receiving text input from employee client device(s) 304. In particular, digital survey 302 can comprise one or more open-ended questions that solicit the employee client device(s) 304 to provide unstructured text responding to the open-ended question. For example, the digital survey 302 can provide the question, “What do you think is the best thing about working at company ABC?” In response, an employee client device can provide the text “management listens to employees and provides constructive feedback.”

In one or more embodiments, the obfuscated summary and modification suggestion system 102 utilizes employee feedback data 306 to generate a prompt 310. In particular, the obfuscated summary and modification suggestion system 102 generates prompt 310 for obfuscation and summary generation large language model 312 to generate a summary of employee feedback data 306. For example, the obfuscated summary and modification suggestion system 102 can generate prompts to generate an obfuscated summary or a non-obfuscated summary (e.g., summarizing without obfuscating) of employee feedback data 306. To illustrate, the obfuscated summary and modification suggestion system 102 can generate prompt 310 by generating a prompt to generate a summary (e.g., not obfuscated) by simply providing the prompt “summarize the following employee feedback data [instances of employee feedback data].” The obfuscated summary and modification suggestion system 102 can generate a prompt to generate an obfuscated summary by providing the prompt “We want to present employee feedback to a manager in a privacy-preserving manner. Summarize the following sentences in an obfuscated & privacy-preserving manner. The summary should be short and should paraphrase the input responses. However, it must capture all the salient points. Do not summarize each sentence one by one. Generate a single holistic summary that captures the employee feedback. It should not be a set of points but a well-rounded summary. There should be a low level of term overlap between the input and summary. Capture only salient points in a clear and concise manner. The input batch that we want to summarize is as follows: [five-ten instances of employee feedback data].” This is only an example of the prompt, and the prompt may include variations.

In one or more embodiments, the obfuscated summary and modification suggestion system 102 generates prompt 310 based on instances of employee feedback data received. Specifically, the obfuscated summary and modification suggestion system 102 can determine whether to generate a prompt comprising instructions for a large language model to generate an obfuscated summary or a summary (e.g., non-obfuscated) of the employee feedback data. For example, the obfuscated summary and modification suggestion system 102 determines to generate an obfuscated summary when the instances of employee feedback data are below a certain number (e.g., thirty responses). If the obfuscated summary and modification suggestion system 102 receives more than a certain number (e.g., thirty-one or more responses), then the obfuscated summary and modification suggestion system 102 will generate a summary of the employee feedback data.

In addition, in one or more embodiments, the obfuscated summary and modification suggestion system 102 utilizes an obfuscated summary threshold to determine whether to generate a prompt comprising instructions for a large language model to generate an obfuscated summary. Specifically, when a number of instances of employee feedback satisfy an obfuscated summary threshold, the obfuscated summary and modification suggestion system 102 can generate a prompt for a large language model to generate an obfuscated summary. For example, instances of employee feedback data satisfy an obfuscated summary threshold when there are thirty or fewer instances of employee feedback data.

Further, the obfuscated summary and modification suggestion system 102 determines to generate a prompt comprising instructions for a large language model to generate a summary (e.g., not obfuscated) of the employee data when a number of instances of employee feedback data does not satisfy an obfuscated summary threshold. For example, instances of employee feedback data do not satisfy an obfuscated summary threshold when there are thirty-one or more instances of employee feedback data.

In one or more embodiments, the obfuscated summary and modification suggestion system 102 determines not to summarize employee feedback when a number of instances of employee feedback data satisfies a minimum employee threshold. Specifically, when the number of instances of employee feedback data satisfies a minimum employee threshold, the obfuscated summary and modification suggestion system 102 does not generate a prompt but simply provides the employee feedback data without summarizing it. For example, a number of instances of employee feedback data satisfies a minimum employee threshold if there are under five instances of employee feedback data (e.g., four or fewer).

As shown, in one or more embodiments, the obfuscated summary and modification suggestion system 102 utilizes or accesses organizational structure data 308 to generate prompt 310. In particular, the obfuscated summary and modification suggestion system 102 utilizes organizational structure data 308 to determine a number of employees that will receive the digital survey 302 and determine whether to generate prompt 310 for a large language model to generate an obfuscated summary. For example, if organizational structure data 308 indicates that a number of employees (or employee client devices) that will receive digital survey 302 satisfies a minimum employee threshold (e.g., less than five employees), then the obfuscated summary and modification suggestion system 102 will not generate a prompt for a large language model to generate an obfuscated summary. In addition, if organizational structure data 308 indicates that the number of employees that will receive digital survey 302 satisfies an obfuscated summary threshold (e.g., 30 or less), the obfuscated summary and modification suggestion system 102 will generate a prompt for a large language model to generate an obfuscated summary. Moreover, if organizational structure data indicates that the number of employees that will receive digital survey 302 does not satisfy an obfuscated summary threshold (e.g., 31 or more), the obfuscated summary and modification suggestion system 102 will generate a prompt for a large language model to generate a summary (e.g., not obfuscated) of employee feedback data.

As shown, and as previously mentioned, the obfuscated summary and modification suggestion system 102 provides prompt 310 to obfuscation and summary generation large language model 312 to generate an obfuscated summary or a summary of employee feedback data 306. Specifically, obfuscation and summary generation large language model 312 is trained (or fine-tuned) to generate obfuscated summaries of employee feedback data. For example, the obfuscated summary and modification suggestion system 102 trains the obfuscation and summary generation large language model 312 by providing prompt 310 with corresponding training employee feedback data and training obfuscated summaries. By providing the obfuscation and summary generation large language model 312 with prompt 310 and corresponding training employee feedback data and training obfuscated summaries, the obfuscated summary and modification suggestion system 102 is able to fine-tune the obfuscation and summary generation large language model to generate precise obfuscated summaries.

As shown, the obfuscated summary and modification suggestion system 102 generates a high-level obfuscated summary 314 or a high-level summary 318. Specifically, the obfuscated summary and modification suggestion system 102 generates a high-level obfuscated summary 314 that comprises a summary of instances of employee feedback data that indicates an overall sentiment identified in the employee feedback data, though obfuscated so that it becomes difficult to trace back to the source employee feedback data. The obfuscated summary and modification suggestion system 102 generates a high-level summary by generating a summary of instances of employee feedback data that indicates an overall sentiment identified in the employee feedback data (but not obfuscated).

As also shown, the obfuscated summary and modification suggestion system 102 generates a topic-level obfuscated summary 316. In particular, a topic-level obfuscated summary 316 indicates an obfuscated summary that summarizes employee feedback data related to a topic identified in employee feedback data. For example, the obfuscated summary and modification suggestion system 102 can identify that employee feedback data comprises feedback related to the topic of “compensation” and generate a topic-level obfuscated summary that summarizes and obfuscates instances of employee feedback related to compensation. In some cases, the obfuscated summary and modification suggestion system 102 determines to generate a topic-level obfuscated summary based on determining to generate a high-level obfuscated summary (e.g., satisfies an obfuscated summary threshold).

Moreover, as shown, the obfuscated summary and modification suggestion system 102 can generate a topic-level summary 320. Specifically, the obfuscated summary and modification suggestion system 102 generates a topic-level summary that summarizes employee feedback data related to a topic identified in employee feedback data (e.g., not obfuscated). For example, the obfuscated summary and modification suggestion system 102 can identify that employee feedback data comprises feedback related to the topic of “workplace culture” and generate a topic-level summary that summarizes feedback related to workplace culture. In some cases, the obfuscated summary and modification suggestion system 102 determines to generate a topic-level summary based on determining to generate a high-level summary (e.g., does not satisfy an obfuscated summary threshold).

In addition, in one or more embodiments, the obfuscated summary and modification suggestion system 102 generates a topic-level obfuscated summary even if the obfuscated summary and modification suggestion system 102 generates a high-level summary (e.g., not obfuscated). In particular, the obfuscated summary and modification suggestion system 102 generates a topic-level obfuscated summary based on identifying that instances of employee feedback data comprising feedback related to a topic satisfy an obfuscated summary threshold, even if a total number of employee feedback data did not satisfy an obfuscated summary threshold. For example, if the obfuscated summary and modification suggestion system 102 receives sixty instances of employee feedback data, but only twenty-five of those instances are related to the topic “teamwork,” the obfuscated summary and modification suggestion system 102 will generate a high-level summary but topic-level obfuscated summary for the topic of “teamwork.”

As previously mentioned, the obfuscated summary and modification suggestion system 102 analyzes the quality of obfuscated summaries. In particular, the obfuscated summary and modification suggestion system 102 generates a semantic similarity metric and a summary quality metric to analyze the quality of obfuscated summaries. FIG. 4 illustrates a schematic diagram of an obfuscated summary and modification suggestion system utilizing a summary quality machine-learning model to analyze an obfuscation and summary generation large language model in accordance with one or more embodiments.

As shown in FIG. 4, the obfuscated summary and modification suggestion system 102 provides employee feedback data 402 to obfuscation and summary generating large language model 404 to generate summaries 406. In particular, the obfuscated summary and modification suggestion system 102 utilizes the obfuscation and summary generating large language model 404 to generate an obfuscated summary 408 and a summary 410 (e.g., a non-obfuscated summary). For example, the obfuscated summary and modification suggestion system 102 can provide a prompt to generate obfuscated summary 408 from employee feedback data 402 and another prompt to generate summary 410 from employee feedback data 402 (e.g., the same instance of employee feedback data).

As shown, the obfuscated summary and modification suggestion system 102 can then utilize a semantic similarity determining machine-learning model 412 to generate a semantic similarity metric 414. Specifically, the obfuscated summary and modification suggestion system 102 generates a semantic similarity metric that measures how closely related or similar the obfuscated summary 408 and the summary 410 are by quantifying the degree of shared meaning. For example, the semantic similarity metric is on a scale from scale from 0 (completely dissimilar) to 1 (identical). A high semantic similarity score (e.g., closer to 1) indicates that the obfuscated summary 408 and the summary 410 are conceptually or contextually close, while a low semantic similarity score (e.g., closer to 0) indicates that the obfuscated summary 408 and the summary 410 are unrelated.

As mentioned, the obfuscated summary and modification suggestion system 102 utilizes the semantic similarity determining machine-learning model 412 to generate the semantic similarity metric 414. In particular, semantic similarity determining machine-learning model 412 is a sentence transformers encoder model that maps sentences and paragraphs from employee feedback data 402 to a dense vector space that can then be used for clustering and semantic search. The obfuscated summary and modification suggestion system 102 utilizes the semantic similarity determining machine-learning model 412 to encode the employee feedback data 402, the obfuscated summary 408, and the summary 410 separately. Then, the obfuscated summary and modification suggestion system 102 finds the cosine difference between the employee feedback data 402 and the obfuscated summary 408 and the employee feedback data 402 and the summary 410 to generate the semantic similarity metric.

As also shown, the obfuscated summary and modification suggestion system 102 generates a summary quality metric 416. In particular, the obfuscated summary and modification suggestion system 102 utilizes the summary quality metric 416 to quantitively express the similarity of obfuscated summary 408 to employee feedback data 402, evaluating the shared content between obfuscated summary 408 and employee feedback data 402. For example, summary quality metric 416 is a scale from zero (completely dissimilar) to one (identical). A summary quality metric 416 closer to zero indicates that there is little overlap between obfuscated summary 408 and employee feedback data 402 (e.g., summary is more obfuscated). A summary quality metric 416 closer to one indicates that there is a high degree of overlap between the obfuscated summary 408 and employee feedback data 402 (e.g., the summary is less obfuscated). In some cases, the obfuscated summary and modification suggestion system 102 generates a summary quality metric by generating a recall-oriented understudy for gisting evaluation (ROUGE) score.

As mentioned, the obfuscated summary and modification suggestion system 102 generates a modification suggestion from employee feedback data. In particular, the obfuscated summary and modification suggestion system 102 utilizes a recommendation large language model to generate one or more modification suggestions from employee feedback data. FIG. 5 illustrates a schematic diagram of an obfuscated summary and modification suggestion system utilizing a recommendation large language model to generate modification suggestions based on employee feedback data.

As shown in FIG. 5, the obfuscated summary and modification suggestion system 102 provides a summary 504 on manager client device 502. For example, as previously described, the obfuscated summary and modification suggestion system 102 provides an obfuscated summary (or a summary) within a manager feedback interface on manager client device 502. In some cases, the manager feedback interface provides a summary within a feedback widget within a manager feedback interface.

As also shown, the obfuscated summary and modification suggestion system 102 receives a request to generate a modification suggestion. In particular, the obfuscated summary and modification suggestion system 102 provides an option to request a modification suggestion within a manager feedback interface on manager client device 502. For example, the obfuscated summary and modification suggestion system 102 generates a selectable option within the manager feedback interface to generate a modification suggestion. As another example, the obfuscated summary and modification suggestion system 102 provides a selectable option within a feedback widget to generate a modification suggestion.

In one or more embodiments, the obfuscated summary and modification suggestion system 102 receives a request to generate a modification suggestion by receiving a text input. Specifically, the obfuscated summary and modification suggestion system 102 receives a text input from the manager client device requesting a modification suggestion. For example, the obfuscated summary and modification suggestion system 102 can receive a text input requesting a modification suggestion regarding a topic. To illustrate, a text input can be “please generate a modification suggestion about work culture.” As another example, the obfuscated summary and modification suggestion system 102 can receive a text input requesting additional information about a summary. To illustrate, a text input can include, “The summary indicates that my employees don't like the work culture, so give me examples of how I can facilitate a better work culture.”

As shown, the obfuscated summary and modification suggestion system 102 generates a prompt 508. In particular, the obfuscated summary and modification suggestion system 102 generates prompt 508 which instructs a large language model to generate a modification suggestion. For example, the obfuscated summary and modification suggestion system 102 can receive a user interaction with an option to generate a modification suggestion and, in response, generate prompt 508 to provide to a large language model (e.g., recommendation large language model 514) to generate the modification suggestion.

In one or more embodiments, the obfuscated summary and modification suggestion system 102 generates prompt 508 based on detecting initiation of an application initiation session on the manager client device 502. Specifically, the obfuscated summary and modification suggestion system 102 detects the initiation of an application session on the manager client device and generates prompt 508. In some cases, the obfuscated summary and modification suggestion system 102 can receive a request to generate a modification suggestion 506 by detecting the initiation of an application session on the manager client device. In other cases, the obfuscated summary and modification suggestion system 102 generates a prompt 508 based on the initiation of the application session.

As shown, prompt 508 can comprise employee feedback data 510. Specifically, the obfuscated summary and modification suggestion system 102 provides unstructured text from employee feedback data 510 as a part of prompt 508. For example, the obfuscated summary and modification suggestion system 102 provides instructions for the large language model to utilize the unstructured text when generating a modification suggestion.

In one or more embodiments, the obfuscated summary and modification suggestion system 102 selects portions of employee feedback data 510 to include in prompt 508. Specifically, the obfuscated summary and modification suggestion system 102 can select a portion of an instance of employee feedback data or multiple instances of employee feedback data. For example, the obfuscated summary and modification suggestion system 102 selects five to ten instances of employee feedback data to include in prompt 508. As another example, the obfuscated summary and modification suggestion system 102 can select five to ten selections from five to ten different instances of employee feedback data.

In addition, in one or more embodiments, the obfuscated summary and modification suggestion system 102 selects employee feedback data 510 based on the request to generate the modification suggestion 506. Specifically, the obfuscated summary and modification suggestion system 102 identifies that the request to generate the modification suggestion 506 requests a specific modification suggestion and selects employee feedback data 510 based on the specific modification suggestion. For example, if the request to generate the modification suggestion 506 comprises a request to generate a modification suggestion based on a topic and the obfuscated summary and modification suggestion system 102 selects employee feedback data 510 corresponding to the topic.

As shown, prompt 508 can also comprise recommendation guidelines 512. In particular, the obfuscated summary and modification suggestion system 102 can provide recommendation guidelines 512 to include as a basis for the modification suggestion. For example, the obfuscated summary and modification suggestion system 102 can instruct a large language model to use recommendation guidelines 512 as a base template for modification suggestions. To illustrate, recommendation guidelines can comprise ‘best practice data’ that indicates guidelines tested to include common recommendations that would work with a variety of companies.

In one or more embodiments, recommendation guidelines 512 are specific to a company of the manager client device 502. In particular, a company associated with the manager client device 502 provides recommendation guidelines 512 indicating information and guidelines for generating modification suggestions for manager client devices corresponding to the company. For example, the obfuscated summary and modification suggestion system 102 generates company-specific prompts utilizing recommendation guidelines 512 for the company and, therefore, modification suggestions unique to the company.

As also shown, the obfuscated summary and modification suggestion system 102 provides prompt 508 to recommendation large language model 514 to generate modification suggestion(s) 516. Specifically, recommendation large language model 514 generates modification suggestions as directed by prompt 508 and based on the employee feedback data provided in prompt 508. For example, prompt 508 can instruct recommendation large language model 514 to generate a modification summary that provides high-level modification suggestions based on the overall employee feedback data and/or topic-level modification suggestions based on topics identified in the employee feedback data. In some cases, recommendation large language model 514 is a Llama large language model. In other cases, recommendation large language model 514 is a Zephyr large language model.

In one or more embodiments, the obfuscated summary and modification suggestion system 102 trains recommendation large language model 514 to generate modification suggestions. Specifically, the obfuscated summary and modification suggestion system 102 utilizes a multi-step training process by first utilizing a pretraining process and then training the recommendation large language model 514. For example, the obfuscated summary and modification suggestion system 102 can pre-train the recommendation large language model to update the recommendation large language model 514 with domain knowledge, then train the recommendation large language model 514 to fine-tune modification suggestions.

In some cases, the obfuscated summary and modification suggestion system 102 utilizes a pretraining dataset to perform the pretraining process. Specifically, the obfuscated summary and modification suggestion system 102 utilizes a pretraining dataset comprised of unstructured text that provides domain knowledge to a base model used for the recommendation large language model 514 (e.g., a large language model with no training and base settings). For example, the pretraining dataset can comprise unstructured text about employee experiences, such as articles about best practices for employee experience.

The obfuscated summary and modification suggestion system 102 can evaluate the pretraining process of recommendation large language model 514. Specifically, the obfuscated summary and modification suggestion system 102 can utilize several different evaluation methods for evaluating the pretraining process of recommendation large language model 514. For example, the obfuscated summary and modification suggestion system 102 can compare semantic similarity to a recommendation text, such as by utilizing an embedding service to generate and manage embeddings. The obfuscated summary and modification suggestion system 102 can utilize the embeddings for comparisons, analyses, and other operations to compare output. In addition, as another example, the obfuscated summary and modification suggestion system 102 can utilize metrics that compare the similarity of machine-generated text, such as a recall-oriented understudy for gisting evaluation (ROUGE) score, a bilingual evaluation understudy (BLEU) score, or a perplexity score. Moreover, as another example, the obfuscated summary and modification suggestion system 102 can utilize a large language model to evaluate pretraining output. Further, as another example, the obfuscated summary and modification suggestion system 102 can label pretraining output (e.g., human-labeled output).

As mentioned, the obfuscated summary and modification suggestion system 102 can update the pretraining process to train (or fine-tune) recommendation large language model 514. Specifically, the obfuscated summary and modification suggestion system 102 utilizes a training dataset to train the recommendation large language model 514 to generate modification suggestions after the pretraining process. For example, the obfuscated summary and modification suggestion system 102 utilizes a training dataset comprising labeled text of recommendations based on training employee feedback data. To illustrate, the obfuscated summary and modification suggestion system 102 provides training employee feedback data to recommendation experts to generate training modification suggestions from the training employee feedback data. The obfuscated summary and modification suggestion system 102 can then modify the recommendation large language model 514 utilizing the modification suggestions.

In addition, the obfuscated summary and modification suggestion system 102 can train recommendation large language model 514 based on comparing modification suggestions. Specifically, the obfuscated summary and modification suggestion system 102 can instruct recommendation large language model 514 to generate multiple modification suggestions based on employee feedback data and update recommendation large language model 514 based on a selection of an optimal modification suggestion. For example, the obfuscated summary and modification suggestion system 102 can direct recommendation large language model 514 to generate two modification selections and select one or the modification suggestions as an optimal modification selection and update recommendation large language model 514 based on selecting the optimal modification selection.

As shown, and as previously mentioned, the obfuscated summary and modification suggestion system 102 generates modification suggestion(s) 516. In particular, the obfuscated summary and modification suggestion system 102 generates modification suggestion(s) 516 by generating modification suggestions by generating one or more modification suggestion(s) 516 for display on the manager client device. In some cases, the obfuscated summary and modification suggestion system 102 generates a set number of modification suggestions. In other cases, the obfuscated summary and modification suggestion system 102 generates a number of modification suggestions based on the amount of modification suggestions indicated in prompt 508.

As also shown, in one or more embodiments, the obfuscated summary and modification suggestion system 102 generates modification suggestion(s) 516 by generating high-level modification suggestion 518. Specifically, the obfuscated summary and modification suggestion system 102 generates high-level modification suggestion 518, which is an overall modification suggestion generated from the employee feedback data. For example, the obfuscated summary and modification suggestion system 102 generates high-level modification suggestion 518 in response to a request to generate a modification suggestion of employee feedback data (e.g., on the whole, without indicating a topic). To illustrate, the obfuscated summary and modification suggestion system 102 can receive a text input of “give me an example of something I can improve” and will generate a high-level modification suggestion 518.

Further, as shown, in one or more embodiments, the obfuscated summary and modification suggestion system 102 generates modification suggestion(s) 516 by generating topic-level modification suggestion 520. Specifically, the obfuscated summary and modification suggestion system 102 generates topic-level modification suggestion 520 that indicates a modification suggestion that relates to a certain topic. For example, the obfuscated summary and modification suggestion system 102 receives a request to generate a modification suggestion related to a topic. To illustrate, the obfuscated summary and modification suggestion system 102 can receive a text input of “give me an example of something I can do to improve my relationship with younger employees,” to which the obfuscated summary and modification suggestion system 102 will and generate a topic-level modification suggestion utilizing the employee feedback data associated with younger employees.

In one or more embodiments, the obfuscated summary and modification suggestion system 102 generates a high-level modification suggestion based on summaries or feedback displayed on the manager client device. Specifically, the obfuscated summary and modification suggestion system 102 can identify a summary or instance of employee feedback data displayed on the manager client device and provide modification suggestions based on that summary or instance of feedback. For example, the obfuscated summary and modification suggestion system 102 can identify that a high-level summary is displayed in the manager feedback interface and determine to generate a high-level modification suggestion.

In addition, in one or more embodiments, the obfuscated summary and modification suggestion system 102 generates a topic-level modification suggestion based on a filter in the manager feedback interface. Specifically, the obfuscated summary and modification suggestion system 102 identifies that the manager feedback interface is filtered based on a topic and generates a topic-level modification suggestion based on the filtered topic. For example, the obfuscated summary and modification suggestion system 102 determines that employee feedback data (or summaries) on the manager feedback interface is filtered by location and determines to generate a topic-level modification suggestion corresponding to the location.

As previously mentioned, the obfuscated summary and modification suggestion system 102 provides summaries and/or modification suggestions within a manager feedback interface. Specifically, the obfuscated summary and modification suggestion system 102 receives user interactions related to displaying summaries and/or modification suggestions within a manager feedback interface on a manager client device. FIGS. 6A-6E illustrate example graphic user interfaces for providing obfuscated summaries and modification summaries in a manager feedback interface in accordance with one or more embodiments.

As shown, the obfuscated summary and modification suggestion system 102 provides manager feedback interface 600. In particular, the obfuscated summary and modification suggestion system 102 causes a manager client device to render the manager feedback interface 600 for displaying obfuscated summaries and/or non-obfuscated summaries. For example, as shown, the obfuscated summary and modification suggestion system 102 provides feedback summary 604 within tab 602 of manager feedback interface 600.

In one or more embodiments, the obfuscated summary and modification suggestion system 102 displays an obfuscated summary based on generating obfuscated summaries of employee feedback data. Specifically, the obfuscated summary and modification suggestion system 102 determines to generate an obfuscated summary based on a number of employee client devices providing employee feedback data satisfying an obfuscated summary threshold. For example, if the obfuscated summary threshold is 30, and 25 employee client devices provide employee feedback data, therefore satisfying the obfuscated summary threshold, the obfuscated summary and modification suggestion system 102 generates an obfuscated summary. Since the obfuscated summary and modification suggestion system 102 determined to generate an obfuscated summary, the obfuscated summary and modification suggestion system 102 will display the obfuscated summary within the feedback summary 604.

Also, in one or more embodiments, the obfuscated summary and modification suggestion system 102 displays an obfuscated summary within feedback summary 604 based on user settings of the manager feedback interface 600. Specifically, the obfuscated summary and modification suggestion system 102 generates obfuscated summaries of employee feedback data based on the user settings of the manager feedback interface and provides the obfuscated summaries within the feedback summary 604. For example, the obfuscated summary and modification suggestion system 102 can provide options for user settings to generate obfuscated summaries within a settings window of the manager feedback interface 600.

In addition, as shown, the obfuscated summary and modification suggestion system 102 displays sentiments in the feedback summary 604. Specifically, the obfuscated summary and modification suggestion system 102 generates one or more sentiments for employee feedback data and displays indications of the sentiment(s) with the obfuscated summary (or summary) within feedback summary 604. For example, the obfuscated summary and modification suggestion system 102 generates text and icons that indicate that the sentiment for overall feedback is mixed within the team and the company.

As shown, manager feedback interface 600 comprises option 606 to generate suggestions. In particular, based on user interaction with option 606, the obfuscated summary and modification suggestion system 102 generates a modification suggestion based on employee feedback data. Additional details and examples of the obfuscated summary and modification suggestion system 102 providing modification suggestions are provided below with respect to FIG. 6B.

In addition, as shown, manager feedback interface 600 also comprises options 608 to filter feedback. Specifically, the obfuscated summary and modification suggestion system 102 generates topic-level obfuscated summaries (or topic-level summaries) based on the selected topic in options 608. Additional details and examples of the obfuscated summary and modification suggestion system 102 generating a topic-level obfuscated summary are provided below with respect to FIGS. 6D-6E.

As shown in FIG. 6B, the obfuscated summary and modification suggestion system 102 provides a modification suggestion based on a selection of option 606 to generate a modification suggestion and displays the modification suggestion(s) in display 610. In particular, based on the selection of option 606, the obfuscated summary and modification suggestion system 102 utilizes recommendation large language model 514 to generate a modification suggestion based on employee feedback data and provides the modification suggestion in display 610. For example, the obfuscated summary and modification suggestion system 102 generates a modification suggestion based on the summary displayed in feedback summary 604 and displays the modification suggestion in display 610.

In one or more embodiments, the obfuscated summary and modification suggestion system 102 provides display 610 based on detecting the initiation of an application session on a manager client device. Specifically, the obfuscated summary and modification suggestion system 102 detects the initiation of an application session of a client application (e.g., client application 120) that renders manager feedback interface 600, generates a modification suggestion, and displays the modification suggestion within display 610. For example, the obfuscated summary and modification suggestion system 102 generates the modification and displays the modification session within display 610 so that the modification suggestion displays shortly after the initiation of the application session on the manager client device.

In addition, as shown, the obfuscated summary and modification suggestion system 102 provides an option for user input about the modification suggestion. Specifically, the obfuscated summary and modification suggestion system 102 generates an updated modification suggestion or an additional modification suggestion based on the user input. For example, if the user input comprises “explain to me how to give specific and constructive feedback,” the obfuscated summary and modification suggestion system 102 can generate an additional modification suggestion addressing the user input. Though the option for user input is shown as part of display 610, it is understood that the option can be any suitable place in manager feedback interface 600.

As shown in FIG. 6C, the obfuscated summary and modification suggestion system 102 displays topic-level summaries in display 612. Specifically, the obfuscated summary and modification suggestion system 102 receives a user selection of a topic in options 608 and generates a topic-level summary of employee feedback data corresponding to the topic. For example, the obfuscated summary and modification suggestion system 102 selects instances of employee feedback data corresponding to the topic and generates an obfuscated summary (or a summary) of the employee feedback data.

As shown, the obfuscated summary and modification suggestion system 102 displays sentiments alongside a topic-level summary in display 612. Specifically, the obfuscated summary and modification suggestion system 102 generates one or more sentiments associated with the topic selected in options 608. For example, the obfuscated summary and modification suggestion system 102 can generate sentiments associated with the topic and provide indications of the sentiments in display 612, such as icons indicated in display 612.

In addition, as shown, the obfuscated summary and modification suggestion system 102 can provide an option to view employee feedback data associated with the topic. In particular, based on selections of the option to view employee feedback data, the obfuscated summary and modification suggestion system 102 displays instances of employee feedback data that are associated with the topic. For example, the obfuscated summary and modification suggestion system 102 can display the text from instances of employee feedback data used to generate the summary of the topic. As another example, the obfuscated summary and modification suggestion system 102 can generate and display obfuscated summaries of instances of employee feedback data associated with the topic.

As shown in FIG. 6D, the obfuscated summary and modification suggestion system 102 also provides additional options to view topics. For example, the obfuscated summary and modification suggestion system 102 provides tab 614 for viewing and exploring topics associated with employee feedback data. As shown, the obfuscated summary and modification suggestion system 102 displays topics 616 relating to topics of employee feedback data. In some cases, the obfuscated summary and modification suggestion system 102 displays topics 616 based on topics identified in employee feedback data. In other cases, the obfuscated summary and modification suggestion system 102 provides topics 616 by providing generally popular topics (e.g., topics about subjects most managers would want to view).

In addition, as shown in FIG. 6E, the obfuscated summary and modification suggestion system 102 also provides option 618 to search for topics. In particular, the obfuscated summary and modification suggestion system 102 receives user input in option 618 to provide a display of topics from employee feedback data. For example, based on the user input of a topic in option 618, the obfuscated summary and modification suggestion system 102 identifies instances of the topic and displays employee feedback data corresponding to the topic. In some cases, the obfuscated summary and modification suggestion system 102 generates an obfuscated summary or topic-level obfuscated summary of the employee feedback data corresponding to the topic and provides the obfuscated summary in the manager feedback interface 600.

As shown in FIG. 6E, the obfuscated summary and modification suggestion system 102 displays topic 620 in the manager feedback interface 600. Specifically, the obfuscated summary and modification suggestion system 102 displays topic 620 based on receiving a user selection of a topic in topics 616 or a user input of a topic in option 618. For example, the obfuscated summary and modification suggestion system 102 can display a topic that comprises sentiments related to the topic and an option to view instances of employee feedback data associated with the topic (or obfuscated summaries of the employee feedback data).

As previously mentioned, the obfuscated summary and modification suggestion system 102 can provide obfuscated summaries and/or modification suggestions in a feedback widget. Specifically, the obfuscated summary and modification suggestion system 102 provides a feedback widget that provides obfuscated summary and modification suggestions associated with text feedback systems. FIGS. 7A-7E illustrate an example feedback widget for providing obfuscated summaries and modification suggestions from employee feedback data in accordance with one or more embodiments.

As shown in FIG. 7A, the obfuscated summary and modification suggestion system 102 provides a summary of topics identified in the feedback widget 700. Specifically, the obfuscated summary and modification suggestion system 102 displays topics 704 identified in employee feedback data. For example, the obfuscated summary and modification suggestion system 102 can display topics identified in survey question 702 of a digital survey provided to employee client devices.

As shown in FIG. 7B, the obfuscated summary and modification suggestion system 102 also displays summary 706 of employee feedback data. In particular, the obfuscated summary and modification suggestion system 102 displays summary 706 by displaying an obfuscated summary or a summary (e.g., not obfuscated). For example, the obfuscated summary and modification suggestion system 102 determines whether to generate an obfuscated summary based on the number of instances of employee feedback data received from employee client devices.

In one or more embodiments, the obfuscated summary and modification suggestion system 102 displays summary 706 based on receiving a user interaction with a topic in topics 704. For example, based on receiving a user selection of the topic ‘leadership’ in topics 704, the obfuscated summary and modification suggestion system 102 provides summary 706 in feedback widget 700. Moreover, in some embodiments, the obfuscated summary and modification suggestion system 102 provides summary 706 based on user interaction with the feedback widget 700. For example, the obfuscated summary and modification suggestion system 102 can receive a user scrolling interaction through the feedback widget and provide summary 706 in another section of the feedback widget based on the user scrolling interaction.

As shown in FIG. 7C, the obfuscated summary and modification suggestion system 102 provides options for user settings for feedback widget 700. In particular, the obfuscated summary and modification suggestion system 102 provides options for displaying summaries and/or modification suggestions in feedback widget 700. For example, as shown, the obfuscated summary and modification suggestion system 102 provides option 708 for providing user settings for displaying employee feedback data for a question of a digital survey. Based on the selection of the survey question, the obfuscated summary and modification suggestion system 102 can display options 710 and options 712 for user settings for the question of the digital survey.

As shown, options 710 provides options to find topics. In particular, the obfuscated summary and modification suggestion system 102 can identify or generate topics from employee feedback data based on the topics from options 710. In some cases, the obfuscated summary and modification suggestion system 102 can also correlate topics selected in options 710 to topics established in a text-matching system (e.g., TEXT IQ from QUALTRICS). For example, based on topics from the text matching system, the obfuscated summary and modification suggestion system 102 can identify topics.

Moreover, as shown in FIG. 7D, the obfuscated summary and modification suggestion system 102 can receive user settings for displays of topics in feedback widget 700. Specifically, the obfuscated summary and modification suggestion system 102 receives user selections of options 714 of displays of topics within feedback widget 700. For example, as shown, the obfuscated summary and modification suggestion system 102 can receive selections of questions from the digital survey, demographic fields, and comparisons.

As shown in FIG. 7E, the obfuscated summary and modification suggestion system 102 displays summaries 716 based on selections of questions to compare in option 718. Specifically, the obfuscated summary and modification suggestion system 102 compares multiple questions from digital surveys to show how sentiments and employee feedback data compare. For example, the obfuscated summary and modification suggestion system 102 displays a summary (e.g., obfuscated or not obfuscated) and corresponding sentiments that indicate the similarities and differences between groups. As illustrated, the obfuscated summary and modification suggestion system 102 displays an indication of the sentiments of a currently selected group of employees (e.g., ‘This team’), the company as a whole (e.g., ‘overall company’), and another group of employees (e.g., ‘Seattle 2021’).

As shown in FIG. 7F, the obfuscated summary and modification suggestion system 102 can also provide filters 720 for source data for the feedback widget 700. Specifically, the obfuscated summary and modification suggestion system 102 provides filter options 722, where the obfuscated summary and modification suggestion system 102 can receive selections of which digital survey to generate summaries and provide additional options for titling and mapping source fields. For example, based on the selection of the digital survey, the obfuscated summary and modification suggestion system 102 receives employee feedback data to generate obfuscated summaries within feedback widget 700.

FIGS. 1-6E, the corresponding text, and the examples provide a number of different methods, systems, devices, and non-transitory computer-readable media of the obfuscated summary and modification suggestion system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

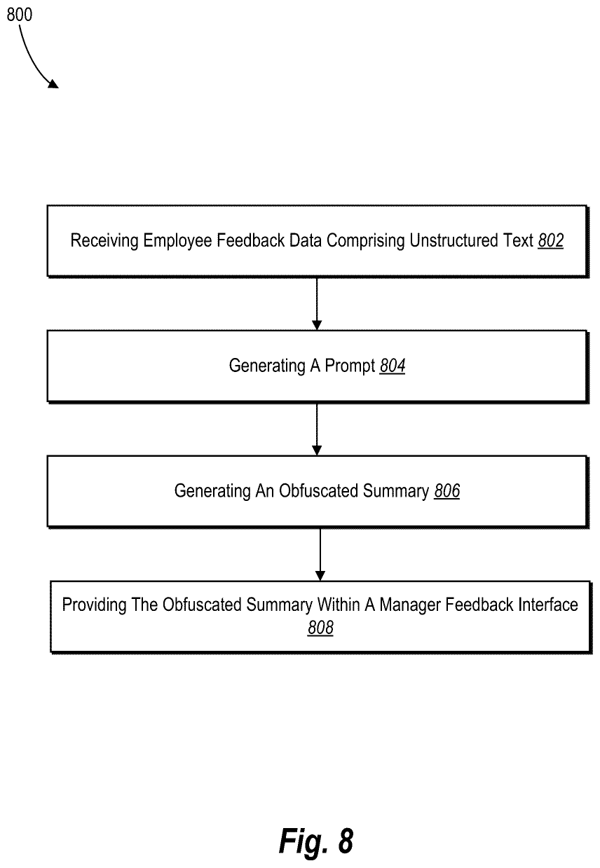

As mentioned, FIG. 8 illustrates a flowchart of a series of acts 800 for generating an obfuscated summary and providing the obfuscated summary within a manager feedback interface in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes an act 802 of receiving employee feedback data comprising unstructured text, an act 804 of generating a prompt, an act 806 of generating an obfuscated summary, and an act 808 of providing the obfuscated summary within a manager feedback interface.

In particular, the act 802 can include receiving employee feedback data comprising unstructured text, the act 804 can include generating a prompt for an obfuscation and summary generation large language model to generate an obfuscated summary of the employee feedback data, the act 806 can include generating, utilizing the obfuscation and summary generation large language model and utilizing the prompt, the obfuscated summary of the employee feedback data, and the act 808 can include providing the obfuscated summary within a manager feedback interface on a manager client device.

For example, in one or more embodiments, the series of acts 800 includes generating a semantic similarity metric and a summary quality metric for the obfuscated summary and utilizing the semantic similarity metric and the summary quality metric to analyze the obfuscates summary from the obfuscation and summary generation large language model.

In addition, in one or more embodiments, the series of acts 800 includes providing the obfuscated summary within the manager feedback interface on the manager client device by providing the obfuscated summary in a feedback widget associated with the manager feedback interface, receiving, within the feedback widget, user input from the manager client device to generate a modification suggestion based on the employee feedback data, and providing the modification suggestion within the feedback widget on the manager client device.

Also, in one or more embodiments, the series of acts 800 includes providing, to an employee client device, a digital feedback survey comprising an option to provide unstructured text and receiving, from the employee client device, a response to the digital feedback survey comprising the employee feedback data.

Further, in one or more embodiments, the series of acts 800 includes wherein generating the prompt for the obfuscation and summary large language generating large language model to generate the obfuscated summary of the employee feedback data is based on determining that a number of employee client devices providing employee feedback data satisfies an obfuscated summary threshold but does not satisfy a minimum employee threshold.

Moreover, in one or more embodiments, the series of acts 800 includes wherein generating the prompt for an obfuscation and summary generation large language model to generate an obfuscated summary further comprises determining that a number of instances of employee feedback data satisfies a minimum feedback threshold and generating the prompt to generate the obfuscated summary of the employee feedback data in response to determining that the number of instances of employee feedback data satisfies the minimum feedback threshold.

In addition, in one or more embodiments, the series of acts 800 includes wherein generating the obfuscated summary of the employee feedback data comprising generating a high-level obfuscated summary for the employee feedback data and one or more topic-level obfuscated summaries of a portion of the employee feedback data.

Further, in one or more embodiments, the series of acts 800 includes receiving, within the manager feedback interface on the manager client device, a user input requesting a display of employee feedback data based on a topic and generating the one or more topic-level obfuscated summaries in response to receiving the user input requesting the display of employee feedback data based on the topic.

Also, in one or more embodiments, the series of acts 800 includes receiving, from the manager client device and within the manager feedback interface, a user selection of an option to filter the employee feedback data by topic, in response to receiving the user selection of the option to filter the employee feedback data by topic, provide the employee feedback data to the obfuscation and summary generation large language model to generate a topic-level obfuscated summary, and providing the topic-level obfuscated summary within the manager feedback interface on the manager client device.

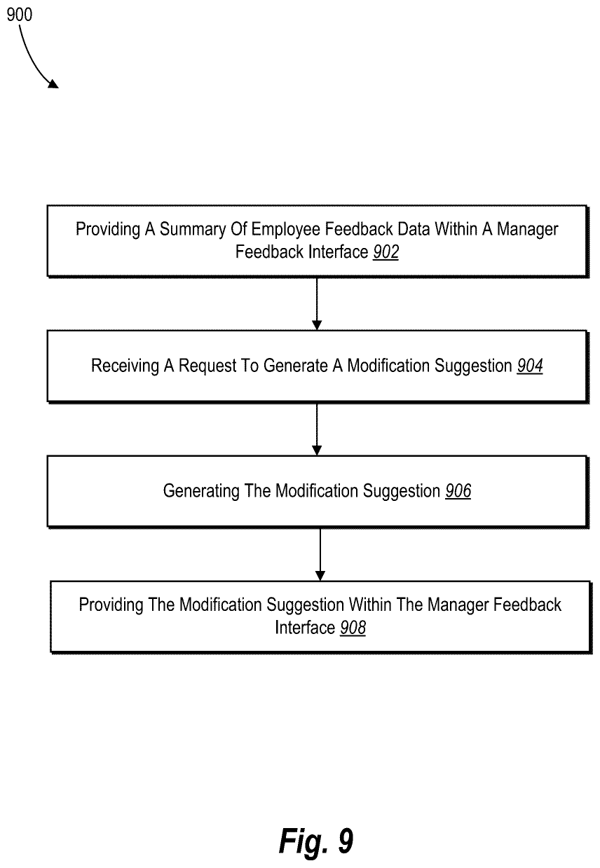

FIGS. 1-6E, the corresponding text, and the examples provide a number of different methods, systems, devices, and non-transitory computer-readable media of the obfuscated summary and modification suggestion system 102. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating a modification suggestion for based on employee feedback data in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 of providing a summary of employee feedback data within a manager feedback interface, an act 904 of receiving a request to generate a modification suggestion, an act 906 of generating the modification suggestion, and an act 908 of providing the modification suggestion within the manager feedback interface.

In particular, the act 902 can include providing a summary of employee feedback data within a manager feedback interface on a manager client device, the act 904 can include receiving, from the manager client device, a request to generate a modification suggestion based on the employee feedback data, the act 906 can include generating the modification suggestion utilizing a recommendation large language model and based on the employee feedback data, and the act 908 can include providing the modification suggestion within the manager feedback interface on the manager client device.

For example, in one or more embodiments, the series of acts 900 includes providing the summary within the manager feedback interface on the manager client device by providing the summary in a feedback widget associated with the manager feedback interface, receiving the request to generate a modification suggestion within the feedback widget, and providing the modification suggestion with the manager feedback interface by providing the modification suggestion within the feedback widget.

In addition, in one or more embodiments, the series of acts 900 includes receiving the employee feedback data, the employee feedback data comprising unstructured text, generating a prompt for an obfuscation and summary generation large language model to generate an obfuscated summary of the employee feedback data, and generating the summary of the employee feedback data by providing the prompt to an obfuscation and summary generation large language model to generate the obfuscated summary of the employee feedback data.

Also, in one or more embodiments, the series of acts 900 includes providing the summary of the employee feedback data within the manager feedback interface by determining that a number of instances of employee feedback data does not satisfy an obfuscated summary threshold and based on determining that the number of instances of employee feedback data does not satisfy the minimum employee threshold, generating the summary of the employee feedback data.

Further, in one or more embodiments, the series of acts 900 includes providing the summary of the employee feedback data within the manager feedback interface by determining that a number of instances of employee feedback data satisfies a minimum employee threshold, based on determining that the number of instances of employee feedback data satisfies the minimum employee threshold, generating the summary of the employee feedback data by generating an obfuscated summary of the employee feedback data, and providing the summary of employee feedback data within the manager feedback interface by providing the obfuscated summary of the employee feedback data.

Moreover, in one or more embodiments, the series of acts 900 includes providing the modification suggestion by receiving, the request to generate the modification suggestion by receiving a request to generate a topic-level modification suggestion based on the employee feedback data, generating, utilizing a obfuscation and summary generation large language model, a topic-level summary of the employee feedback data, and providing the modification suggestion by providing the topic-level summary of the employee feedback data within the manager feedback interface on the manager client device.

Additionally, in one or more embodiments, the series of acts 900 includes generating an obfuscated summary of employee feedback data by generating a prompt for an obfuscation and summary generation large language model to generate an obfuscated summary of the employee feedback data and utilizing the obfuscation and summary generation large language model to generate the obfuscated summary, providing the obfuscated summary of the employee feedback data within a manager feedback interface on a manager client device, receiving, from the manager client device, a request to generate a modification suggestion based on the employee feedback data and, in response to receiving the request to generate the modification suggestion, generate the modification suggestion utilizing a recommendation large language model.

Also, in one or more embodiments, the series of acts 900 includes providing the modification suggestion in the manager feedback interface on the manager client device.

Moreover, in one or more embodiments, the series of acts 900 includes providing, to an employee client device, a digital feedback survey comprising an option to provide unstructured text and receiving the employee feedback data by receiving, from the employee client device, a response to the digital feedback survey comprising unstructured text corresponding to the option to provide unstructured text about the manager performance.

Further, in one or more embodiments, the series of acts 900 includes determining that a number of employee client devices providing employee feedback data satisfies a minimum employee threshold and generating the obfuscated summary of the employee feedback data based on determining that the number of employee client devices providing employee feedback data satisfies the minimum employee threshold.

Additionally, in one or more embodiments, the series of acts 900 includes receive, from the manager client device, a request to generate a topic-level obfuscated summary of the employee feedback data and in response to receiving the request to generate the topic-level obfuscated summary of the employee feedback data, generate the topic-level obfuscated summary utilizing the obfuscation and summary generation large language model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., computing device 1000, server(s) 106, client devices 114a-114n, manager client device 118, third-party server(s) 122, and third-party server(s) 126). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

FIG. 11 illustrates an example network environment 1100 of an experience management system 104 (e.g., the experience management system 104, including the obfuscated summary and modification suggestion system 102). The network environment 1100 includes an experience management system 104 and a client device 1104, connected to each other by a network 1102. Although FIG. 11 illustrates a particular arrangement of the client device 1104, the experience management system 104, and the network 1102, this disclosure contemplates any suitable arrangement of the client device 1104, the experience management system 104, and the network 1102. As an example, and not by way of limitation, two or more of the client devices 1104 and the experience management system 104 communicate directly, bypassing the network 1102. As another example, two or more of the client devices 1104 and the experience management system 104 may be physically or logically co-located with each other in whole or in part. Moreover, although FIG. 11 illustrates a particular number of the client device 1104, the experience management system 104, and the network 1102, this disclosure contemplates any suitable number of client devices 1104, experience management systems 104, and networks 1102. As an example, and not by way of limitation, the network environment 1100 may include multiple client devices 1104, multiple experience management systems 104, and multiple networks 1102.

This disclosure contemplates any suitable network 1102. As an example, and not by way of limitation, one or more portions of the network 1102 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1102 may include one or more networks 1102.

Links may connect the client device 1104 and the experience management system 104 to the network 1102 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1100. One or more first links may differ in one or more respects from one or more second links.

In particular embodiments, the client device 1104 may be an electronic device including hardware, software, or embedded logic components or a combination of two or more such components and capable of carrying out the appropriate functionalities implemented or supported by the client device 1104. As an example, and not by way of limitation, a client device 1104 may include any of the computing devices discussed above in relation to FIG. 8. A client device 1104 may enable a network user at the client device 1104 to access a network. A client device 1104 may enable its user to communicate with other users at other client devices 1104. A client device 1104 can be the manager client device 118. A client device 1104 can be the user employee client device(s) 114a-114n. A client device 1104 can include both the manager client device 118 and the user employee client device(s) 114a-114n.

In particular embodiments, the client device 1104 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1104 may enter a Uniform Resource Locator (“URL”) or other address directing the web browser to a particular server (such as the server(s) 106), and the web browser may generate a Hyper Text Transfer Protocol (“HTTP”) request and communicate the HTTP request to the server. The server may accept the HTTP request and communicate to the client device 1104 one or more Hyper Text Markup Language (“HTML”) files responsive to the HTTP request. The client device 1104 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

The experience management system 104 may be accessed by the other components of the network environment 1100 either directly or via network 1102. In particular embodiments, the experience management system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the experience management system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1104 or the experience management system 104 to manage, retrieve, modify, add, or delete, the information stored in data storage.

In particular embodiments, the experience management system 104 may be capable of linking a variety of entities. As an example, and not by way of limitation, the experience management system 104 may enable multiple users and/or agents to interact with each other or other entities, or to allow users and/or agents to interact with these entities through an application programming interface (“API”) or other communication channels.

In particular embodiments, the experience management system 104 may include a variety of servers, sub-systems, programs, modules, logs, and data stores. In particular embodiments, the experience management system 104 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The experience management system 104 may also include suitable components such as network interfaces, security mechanisms, load balancers, failover servers, management-and-network-operations consoles, other suitable components, or any suitable combination thereof.

In particular embodiments, the experience management system 104 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., customers, etc.).

The web server may include a mail server or other messaging functionality for receiving and routing messages between the experience management system 104 and one or more client devices 1104. An action logger may be used to receive communications from a web server about a user's actions on or off the experience management system 104. In conjunction with the action log, a third-party-content-object log may be maintained of user exposures to third-party-content objects. A notification controller may provide information regarding content objects to the client device 1104. Information may be pushed to the client device 1104 as notifications, or information may be pulled from the client device 1104 responsive to a request received from the client device 1104. Authorization servers may be used to enforce one or more privacy settings of the users of the experience management system 104. A privacy setting of a user determines how particular information associated with a user can be shared. The authorization server may allow users to opt in to or opt out of having their actions logged by the experience management system 104 or shared with other systems, such as, for example, by setting appropriate privacy settings. Third-party-content-object stores may be used to store content objects received from third parties. Location stores may be used for storing location information received from the client devices 1104 associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving employee feedback data comprising unstructured text;
generating a prompt for an obfuscation and summary generation large language model to generate an obfuscated summary of the employee feedback data;
generating, utilizing the obfuscation and summary generation large language model and utilizing the prompt, the obfuscated summary of the employee feedback data; and
providing the obfuscated summary within a manager feedback interface on a manager client device.

2. The computer-implemented method of claim 1, further comprising:
generating a semantic similarity metric and a summary quality metric for the obfuscated summary; and
utilizing the semantic similarity metric and the summary quality metric to analyze the obfuscated summary from the obfuscation and summary generation large language model.

3. The computer-implemented method of claim 1, further comprising:
providing the obfuscated summary within the manager feedback interface on the manager client device by providing the obfuscated summary in a feedback widget associated with the manager feedback interface;
receiving, within the feedback widget, user input from the manager client device to generate a modification suggestion based on the employee feedback data; and
providing the modification suggestion within the feedback widget on the manager client device.

4. The computer-implemented method of claim 1, wherein receiving the employee feedback data comprising unstructured text further comprises:
providing, to an employee client device, a digital feedback survey comprising an option to provide unstructured text; and
receiving, from the employee client device, a response to the digital feedback survey comprising the employee feedback data.

5. The computer-implemented method of claim 1, wherein generating the prompt for the obfuscation and summary generation large language model to generate the obfuscated summary of the employee feedback data is based on determining that a number of employee client devices providing employee feedback data satisfies an obfuscated summary threshold but does not satisfy a minimum employee threshold.

6. The computer-implemented method of claim 1, wherein generating the prompt for an obfuscation and summary generation large language model to generate an obfuscated summary further comprises:
determining that a number of instances of employee feedback data satisfies a minimum feedback threshold; and
generating the prompt to generate the obfuscated summary of the employee feedback data in response to determining that the number of instances of employee feedback data satisfies the minimum feedback threshold.

7. The computer-implemented method of claim 1, wherein generating the obfuscated summary of the employee feedback data comprising generating a high-level obfuscated summary for the employee feedback data and one or more topic-level obfuscated summaries of a portion of the employee feedback data.

8. The computer-implemented method of claim 7, further comprising:
receiving, within the manager feedback interface on the manager client device, a user input requesting a display of employee feedback data based on a topic; and
generating the one or more topic-level obfuscated summaries in response to receiving the user input requesting the display of employee feedback data based on the topic.

9. The computer-implemented method of claim 1, further comprising:
receiving, from the manager client device and within the manager feedback interface, a user selection of an option to filter the employee feedback data by topic;
in response to receiving the user selection of the option to filter the employee feedback data by topic, provide the employee feedback data to the obfuscation and summary generation large language model to generate a topic-level obfuscated summary; and
providing the topic-level obfuscated summary within the manager feedback interface on the manager client device.

10. A non-transitory computer-readable medium storing instructions that, when executed by at least one processor, cause a computer system to:
provide a summary of employee feedback data within a manager feedback interface on a manager client device;
receive, from the manager client device, a request to generate a modification suggestion based on the employee feedback data;
generate the modification suggestion utilizing a recommendation large language model and based on the employee feedback data; and
provide the modification suggestion within the manager feedback interface on the manager client device.

11. The non-transitory computer-readable medium of claim 10, further comprising instructions that, when executed by the at least one processor, cause the computer system to:
provide the summary within the manager feedback interface on the manager client device by providing the summary in a feedback widget associated with the manager feedback interface;
receive the request to generate a modification suggestion within the feedback widget; and
provide the modification suggestion with the manager feedback interface by providing the modification suggestion within the feedback widget.

12. The non-transitory computer-readable medium of claim 10, further comprising instructions that, when executed by the at least one processor, cause the computer system to:
receive the employee feedback data, wherein the employee feedback data comprising unstructured text;
generate a prompt for an obfuscation and summary generation large language model to generate an obfuscated summary of the employee feedback data; and
generate the summary of the employee feedback data by providing the prompt to an obfuscation and summary generation large language model to generate the obfuscated summary of the employee feedback data.

13. The non-transitory computer-readable medium of claim 10, further comprising instructions that, when executed by the at least one processor, cause the computer system to provide the summary of the employee feedback data within the manager feedback interface by:
determining that a number of instances of employee feedback data does not satisfy an obfuscated summary threshold; and
based on determining that the number of instances of employee feedback data does not satisfy the obfuscated summary threshold, generating the summary of the employee feedback data.

14. The non-transitory computer-readable medium of claim 10, further comprising instructions that, when executed by the at least one processor, cause the computer system to provide the summary of the employee feedback data within the manager feedback interface by:
determining that a number of instances of employee feedback data satisfies an obfuscated summary threshold;
based on determining that the number of instances of employee feedback data satisfies the obfuscated summary threshold, generating the summary of the employee feedback data by generating an obfuscated summary of the employee feedback data; and
providing the summary of employee feedback data within the manager feedback interface by providing the obfuscated summary of the employee feedback data.

15. The non-transitory computer-readable medium of claim 10, further comprising instructions that, when executed by the at least one processor, cause the computer system to provide the modification suggestion by:
receiving, the request to generate the modification suggestion by receiving a request to generate a topic-level modification suggestion based on the employee feedback data;
generating, utilizing an obfuscation and summary generation large language model, a topic-level summary of the employee feedback data; and
providing the modification suggestion by providing the topic-level summary of the employee feedback data within the manager feedback interface on the manager client device.

16. A system comprising:
at least one processor; and
at least one non-transitory computer-readable storage medium storing instructions that, when executed by the at least one processor, cause the system to:
generate an obfuscated summary of employee feedback data by generating a prompt for an obfuscation and summary generation large language model to generate an obfuscated summary of the employee feedback data and utilizing the obfuscation and summary generation large language model to generate the obfuscated summary;
provide the obfuscated summary of the employee feedback data within a manager feedback interface on a manager client device;
receive, from the manager client device, a request to generate a modification suggestion based on the employee feedback data; and
in response to receiving the request to generate the modification suggestion, generate the modification suggestion utilizing a recommendation large language model.

17. The system of claim 16, further comprising instructions that, when executed by the at least one processor, cause the system to provide the modification suggestion in the manager feedback interface on the manager client device.

18. The system of claim 16, further comprising instructions that, when executed by the at least one processor, cause the system to:
provide, to an employee client device, a digital feedback survey comprising an option to provide unstructured text; and
receive the employee feedback data by receiving, from the employee client device, a response to the digital feedback survey comprising unstructured text corresponding to the option to provide unstructured text about a manager performance.

19. The system of claim 16, further comprising instructions that, when executed by the at least one processor, cause the system to:
determine that a number of employee client devices providing employee feedback data satisfies a minimum employee threshold; and
generate the obfuscated summary of the employee feedback data based on determining that the number of employee client devices providing employee feedback data satisfies the minimum employee threshold.

20. The system of claim 16, further comprising instructions that, when executed by the at least one processor, cause the system to:
receive, from the manager client device, a request to generate a topic-level obfuscated summary of the employee feedback data; and
in response to receiving the request to generate the topic-level obfuscated summary of the employee feedback data, generate the topic-level obfuscated summary utilizing the obfuscation and summary generation large language model.
